(19) United States
(12) Patent Application Publication
(10) Pub. No.: US 2023/0025392 A1
(43) Pub. Date: Jan. 26, 2023

(54) METHOD AND SYSTEM FOR A HUB DEVICE

(71) Applicant: Doma Casa, LLC, Holland, MI (US)

(72) Inventor: Bradley MacLean, Holland, MI (US)

(73) Assignee: Doma Casa, LLC, Holland, MI (US)

(21) Appl. No.: 17/869,555

(22) Filed: Jul. 20, 2022

Related U.S. Application Data
(60) Provisional application No. 63/224,162, filed on Jul. 21, 2021.

(51) Int. Cl. G08B 19/00; G08B 25/00; G08B 25/10

(52) U.S. Cl. CPC G08B 19/00; G08B 25/009; G08B 25/10

(57) ABSTRACT

A hub device including a housing defining an interior, a plurality of sensors, and a controller module. The plurality of sensors being provided within the interior or along a portion of the housing. The controller module having access to a memory comprising a set of preloaded software and a set of additional software. At least one of least one of the set of preloaded software or the set of additional software is configured to allow the hub device to be communicatively couplable to at least one additional hardware.

### TECHNICAL FIELD

The disclosure generally relates to a hub device, specifically to a hub device including a communication device, an input device, and a hardware device.

### BACKGROUND

Environments (e.g., a household environment) today can include one or more hardware components that each perform a function of set of functions to assist in the function or use of the environment. For example, an exemplary environment can be a kitchen environment that includes a set of hardware components such as a smoke detector, an O2 detector, a carbon monoxide detector, a light source, a speaker, a timer, an Artificial Intelligence (AI) device, or the like. In most cases, these hardware components are separate and discrete from one another. In other words, the smoke detector is separate from the light source and the AI device.

### BRIEF DESCRIPTION

In one aspect, the disclosure relates to a hub device comprising a housing defining an interior, a plurality of sensors provided within the interior or along a portion of the housing, and a controller module having access to a memory comprising a set of preloaded software that is pre-existing on the memory before an installation of the hub device, the set of preloaded software being configured to allow the hub device to perform according to a first set of functions using at least one sensor of the plurality of sensors and a set of additional software that is saved to the memory after the installation or the production of the hub device, the set of additional software being configured to allow the hub device to perform according to a second set of functions using at least one sensor of the plurality of sensors, with the first set of functions being different from the second set of functions, wherein at least one additional hardware that is not preexisting on or with the hub device, and wherein at least one of the set of preloaded software or the set of additional software is configured to allow the at last one additional hardware to be communicatively couplable to the hub device.

In another aspect, the disclosure relates to a method of defining a functionality of a hub device having a plurality of sensors and a controller module with a memory accessible to the controller module, the method comprising saving a first set of software to the memory during production of the hub device, the first set of software defining a first set of functions utilizing at least one sensor of the plurality of sensors, saving a second set of software to the memory after production of the hub device, the second set of software defining a second set of functions, different from the first set of function, and communicating with an additional hardware that is not preexisting on or with the hub device, and wherein at least one of the set of preloaded software or the set of additional software is configured to allow the hub device to be communicatively couplable to the hub device.

### BRIEF DESCRIPTION OF THE DRAWINGS

A full and enabling disclosure of the present description, including the best mode thereof, directed to one of ordinary skill in the art, is set forth in the specification, which refers to the appended FIGS., in which:

FIG. 1 is a schematic perspective view of a hub device including a set of input devices, a set of output devices, and a set of communication devices.

FIG. 2 is a schematic diagram of the hub device of FIG. 1, further including a controller module accessible to the hub device.

FIG. 3 is a schematic exploded view of the hub device of FIG. 1, further illustrating an interior of the hub device including at least a portion of the set of output devices, the set of input devices, the set of communication devices, and the controller module.

FIG. 4 is perspective view of an environment including the hub device of FIG. 1, further illustrating an exemplary set of communications between a user and the hub device, the exemplary set of communications including a voice command from the user.

FIG. 5 is perspective view of an exemplary environment including the hub device of FIG. 1, further illustrating an exemplary set of communications between a user and the hub device, the exemplary set of communications including an exemplary voice command from the user.

FIG. 6 is a perspective view of an exemplary environment including the hub device of FIG. 1, further illustrating an exemplary set of communications between the exemplary environment and the hub device, the exemplary set of communications including a threat from the environment.

FIG. 7 is a perspective view of an exemplary environment including the hub device of FIG. 1, further illustrating an exemplary set of communications between the exemplary environment and the hub device, the exemplary set of communications including an exemplary threat from the environment.

FIG. 8 is a perspective view of an exemplary environment including the hub device of FIG. 1, further illustrating an exemplary communication between the environment and the hub device, the exemplary communication including a projection from the hub device.

FIG. 9 is a perspective view of an exemplary environment including the hub device of FIG. 1, further illustrating an exemplary communication between a user and the hub device, the exemplary communication including a projection of a second environment.

FIG. 10 is a perspective view of an exemplary environment including the hub device of FIG. 1, further illustrating a set of communications between a set of users and the hub device.

FIG. 11 is a schematic perspective view of a set of environments each including a hub device of the set of hub devices of FIG. 1, further illustrating a set of communications between a set of users, the set of hub devices, a set of objects.

FIG. 12 is a schematic diagram of a communication environment including a set of hub devices including the hub device of FIG. 1.

FIG. 13 is a programming environment for the hub device of FIG. 1.

### DETAILED DESCRIPTION

Aspects of the disclosure described herein are broadly directed to a hub device suitable for use within a set of environments. As used herein, the term “hub device” or iterations thereof refers to a device including a set of hardware devices packaged or received within or otherwise directly coupled to a casing, with each hardware device of the set of hardware devices being configured to perform a set of hardware functions that differ from the hardware functions of the other hardware devices within the hub device. As used herein, the term “hardware functions” or iterations thereof can be defined as one or more processes, tasks, or activities that the hardware device of the hub device can perform. As a non-limiting example, hardware functions can include, but are not limited to, sensing, reading, communicating, transmitting, receiving, projecting, computing, or any combination thereof. The hardware devices of the hub device can include, but are not limited to, a set of communication devices, a set of input devices, and a set of output devices. The set of input devices can be configured to detect, measure, receive or otherwise obtain a set of data or a set of characteristics relating to the environment. The set of output devices can be configured to project or otherwise transmit a communication into the environment. The set of communication devices can be configured to connect with, communicate with, or otherwise share data with one or more corresponding devices (e.g., communication devices) within the environment.

Each hardware device of the set of hardware devices can be configured to perform at least one pre-programmed function. In other words, the hub device can be manufactured such that it can perform a set of hardware functions without additional programming (e.g., the hub device can be operable or otherwise perform the set of hardware functions after being manufactured). It will be appreciated, however, that the hub device can include a set of software devices or capabilities that can allow for the hub device to be reprogrammed such that the hub device can perform hardware functions beyond the original pre-programmed hardware functions. In other words, a user of the hub device can redefine or otherwise reprogram the hardware functions of the hub device through use of the software devices provided within or otherwise accessible to the hub device. As used herein, the term “user” or iterations thereof can refer to a person who is utilizing the hub device or at least a portion of the functions of the hub device for personal use or as a developer (e.g., a person who is using the hub device to create an application for the hub device or to otherwise change/reprogram the hardware functions of the hub device).

The hub device as described herein can be used in any suitable environment. As a non-limiting example, the hub device can be provided within a residential environment (e.g., a room within a house, an apartment, etc.). It will be appreciated, however, that the hub device can be provided within any other suitable environment such as, but not limited to, a commercial environment (e.g., a store), a vehicle, or any other suitable environment.

While “a set of” various elements will be described, it will be understood that “a set” can include any number of the respective elements. It will be yet further understood that the “a set” can include only one element. Also, as used herein, while elements or components can be described as “sensing” or “measuring” a respective value, data, function, or the like, sensing or measuring can include determining a value indicative of or related to the respective value, data, function, or the like, rather than directly sensing or measuring the value, data, function, or the like, itself. The sensed or measured value, data, function, or the like, can further be provided to additional components. For instance, the value can be provided to a controller module or processor, and the controller module or processor can perform processing on the value to determine a representative value or an electrical characteristic representative of said value, data, function, or the like.

Connection references (e.g., attached, coupled, connected, and joined) are to be construed broadly and can include intermediate members between a collection of elements and relative movement between elements unless otherwise indicated. As such, connection references do not necessarily infer that two elements are directly connected and in fixed relation to each other. In non-limiting examples, connections or disconnections can be selectively configured to provide, enable, disable, or the like, an electrical connection between respective elements. Non-limiting example power distribution bus connections or disconnections can be enabled or operated by way of switching logic, or any other connectors configured to enable or disable the connection between respective elements or component.

As used herein, a “system” or a “controller module” can include at least one processor and memory. Non-limiting examples of the memory can include Random Access Memory (RAM), Read-Only Memory (ROM), flash memory, or one or more different types of portable electronic memory, such as discs, Digital Versatile Discs (DVDs), Compact Disc—Read Only Memory (CD-ROMs), etc., or any suitable combination of these types of memory. The processor can be configured to run any suitable programs or executable instructions designed to carry out various methods, functionality, processing tasks, calculations, or the like, to enable or achieve the technical operations or operations described herein. The program can include a computer program product that can include machine-readable media for carrying or having machine-executable instructions or data structures stored thereon. Such machine-readable media can be any available media, which can be accessed by a general purpose or special purpose computer or other machine with a processor. Generally, such a computer program can include routines, programs, objects, components, data structures, algorithms, etc., that have the technical effect of performing particular tasks or implement particular abstract data types.

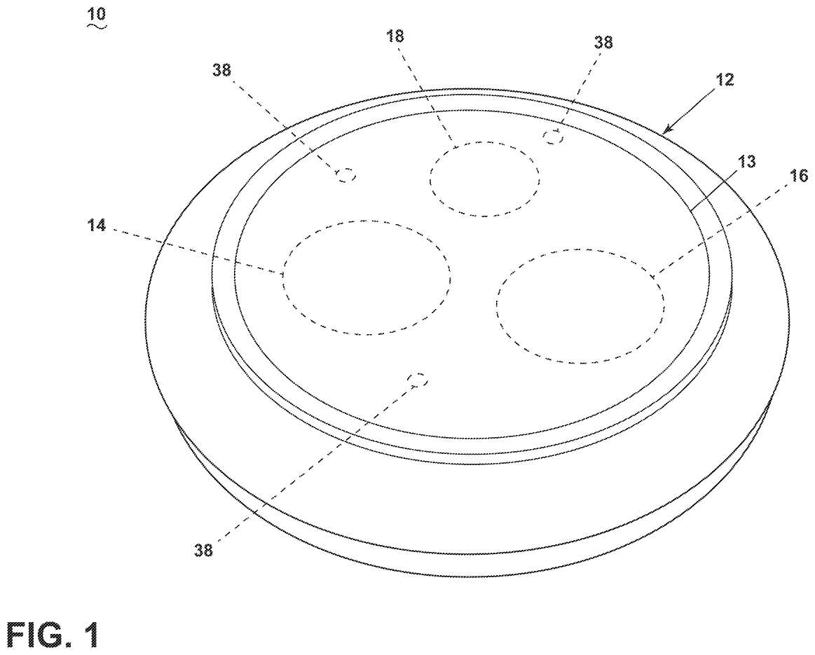

FIG. 1 is a schematic perspective view of a hub device 10 including a set of hardware devices. As such, the hub device 10 can be defined as a hardware hub device 10. The set of hardware devices can include at least a set of input devices 14, a set of output devices 16, and a set of communication devices 18. The hub device 10 can further include a casing 12 at least partially encasing at least a portion of the set of input devices 14, the set of output devices 16, and the set of communication devices 18.

The hub device 10 can be in the form of a disc or a saucer. As a non-limiting example, the casing 12 can be in the form of a disc or a saucer with an at least partially hollow interior such that at least a portion of the set of input devices 14, the set of output devices 16, and the set of communication devices 18 can be received within the hollow interior of the casing 12. It will be appreciated, however, that the casing 12, and hence the hub device 10, can include any suitable shape such as, but not limited to, a rectangular prism, a pyramid, a sphere, a semi-sphere, or any combination thereof. At least a portion of the casing 12 can be defined by an outer face 13, which can be generally flat or otherwise include a planar topography. At least a portion of the set of input devices 14, the set of output devices 16, and the set of communication devices 18 can be located along a portion of the outer face 13.

The set of input devices 14 can be defined as any suitable device configured to detect, measure, receive or otherwise obtain a set of data or a set of characteristics from a portion exterior the hub device 10. As illustrated, at least a portion of the set of input devices 14 can be provided along the outer face 13 of the casing 12. As a non-limiting example, one input device 14 of the set of input devices 14 can be a carbon monoxide sensor configured to sense, or otherwise detect for the presence of carbon monoxide in a portion exterior of the hub device 10. The set of input devices 14 can include at least one of any suitable device such as, but not limited to, set of sensors (e.g., a carbon monoxide sensor, an O2 sensor, a motion sensor, a proximity sensor, a smoke sensor, a temperature sensor, a humidity sensor, a pressure sensor, a vibration sensor, a thermal sensor, an optical sensor, a dust sensor, a gas sensor, a distance sensor, a motion sensor, a light sensor, a color sensor, a flame sensor, a gesture sensor, barometric sensor, an air quality sensor, a human presence sensor, or any other suitable sensor), a set of microphones, a set of optical devices (e.g., a camera in the visible and/or non-visible light spectrum), a set of scanners (e.g., a RADAR device, a LIDAR device, an ultrasound device, or any other suitable scanner), a set of mechanical inputs (e.g., a button, a switch, a knob, a keypad, etc.), or any combination thereof. As a non-limiting example, the set of input devices 14 can include an optical camera that includes a lens provided on the outer face 13 of the casing 12.

The set of output devices 16 can be defined as any suitable device configured to project or otherwise transmit a communication into an environment that hub device 10 is provided within. Similar to the set of input devices 14, at least a portion of the set of output devices 16 can be provided along the outer face 13 of the casing 12. As a non-limiting example, a set of lights 38 can be included within the set of output devices 16 and be provided along the casing 12. As a non-limiting example, the set of lights 38 can be provided along the outer face 13. It will be appreciated, that the set of lights 38 can be provided within a single location of the casing 12 or differing locations as illustrated. Each light 38 of the set of lights 38 can define a light source that outputs or otherwise transmits light into the environment the hub device 10 is provided within. Each light 38 can include a wavelength in the visible or non-visible spectrum that differs from the other lights 38. As a non-limiting example, one of the lights 38 can include a wavelength that emits a green light, another light 38 can include a wavelength that emits a red light, and the remaining light 38 can include a wavelength that emits a blue light. The set of lights 38 or any other light source can be any suitable light such as, but not limited to, a Light Emitting Diode (LED) light source, a halogen light source, an incandescent light source, a fluorescent light source, a non-visible light source (e.g., an Ultraviolet (UV) light source), or any combination thereof. Alternatively, at least two lights 38 of the set of lights 38 can include the same wavelength. The set of output devices 16 can include any other suitable output device 16 such as, but not limited to, a set of optical output devices (e.g., the set of lights 38, a light array 40, a projector, etc.), a set of audible devices (e.g., a speaker, a buzzer, a horn, a mechanical device such as a clicker, etc.), or any combination thereof.

The set of communication devices 18 can be any suitable communication device 18 configured to connect with, communicate with, or otherwise share a set of hub data with one or more corresponding devices (e.g., communication devices) within the environment that the hub device 10 is provided within. As used herein, the term “hub data” or iterations thereof can be defined as a single piece or a set of numerical, alphabetic, or alphanumerical elements received or generated by the hub device 10 that directly relate to the operation of the hub device 10. As a non-limiting example, the set of hub data can include a command sent from a user (e.g., a verbal command, a physical command, a command transmitted through a user's phone, etc.). As a non-limiting example, the set of hub data can include one or more sets of data gathered, or otherwise generated by the set of input devices 14 (e.g., the presence of smoke, O2, a person, etc.), or the set of output devices 16 (e.g., the actuation of the set of lights 38, a speaker, etc.). As a non-limiting example, the set of communication devices 18 can include a Bluetooth module configured to pair with and send/receive communications between a corresponding Bluetooth module or Bluetooth enabled device (e.g., a phone) within the environment the hub device 10 is provided within. The set of communication devices 18 can be any other suitable communication device 18 such as, but not limited to, a Bluetooth module, a WIFI module, a wireless network module (e.g., a wireless mesh network module), a radio transmitter/receiver, or any other suitable communication device 18. It will be further appreciated that the communication devices 18 can be defined by a wired connection. As a non-limiting example, the communication device 18 can include an ethernet connection connected to an ethernet cable, or any other suitable connection connected to any suitable wired device configured to transfer data.

Although the set of input devices 14, the set of output devices 16 including the set of lights 38, and the set of communication devices 18 are illustrated as three circles provided on the casing of the hub device 10, it will be appreciated that the set of input devices 14, the set of output devices 16, and the set of communication devices 18 can take any shape or form along the casing 12 of the hub device 10. Further, it will be appreciated that the set of input devices 14, the set of output devices 16 including the set of lights 38, and the set of communication devices 18 can be positioned along any portion of the casing 12 with respect to one another. Further yet, it will be appreciated that at least one of the set of input devices 14, the set of output devices 16 including the set of lights 38, and the set of communication devices 18 can be provided along one or more locations along the casing 12 of the hub device 10, or they can be provided entirely within the interior of the casing 12 such that they are not visible from the exterior of the hub device 10.

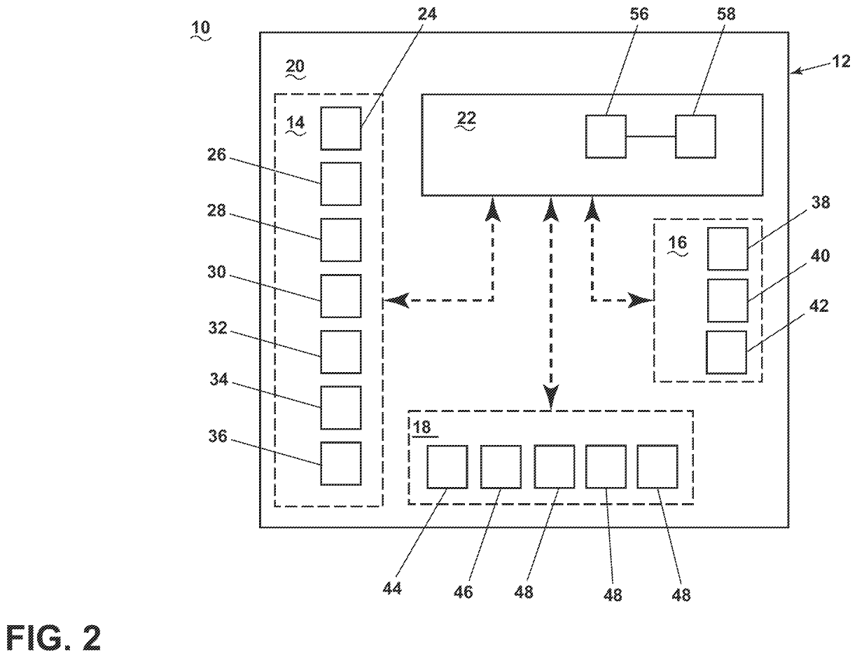

FIG. 2 is a schematic diagram of the hub device 10 of FIG. 2. The hub device 10 can include the casing 12, which defines an interior 20. As illustrated, at least a portion of the set of input devices 14, the set of output devices 16, the set of communication devices 18, and a controller module 22 can be provided within the interior 20. The hub device 10 can further include a controller module 22 accessible to the hub device 10. As used herein, the term “accessible to” or iterations thereof, can refer to the capability of a device (e.g., the hub device 10) to utilize the functions of a specific element that is either provided within the hub device 10 or exterior to the hub device 10. The set of input devices 14, the set of output device 16, and the set of communication devices 18 can, together, form the hardware functions, as described herein, of the hub device 10.

The set of input devices 14 can include a set of input hardware devices. As a non-limiting example, the set of input devices 14 can include a motion sensor 24, a smoke sensor 26, a Carbon Monoxide (CO) sensor 28, a camera 30, a temperature and humidity sensor 32, a microphone 34, and a scanner 36. Although only the motion sensor 24, the smoke sensor 26, the Carbon Monoxide (CO) sensor 28, the camera 30, the temperature and humidity sensor 32, the microphone 34, and the scanner 36 are illustrated, it will be appreciated that the set of input devices 14 can include any suitable input device 14 as described herein. It will be further appreciated that the set of input devices 14 can include any one or more of, or none of the input devices 14 as described herein.

The motion sensor 24 can be any suitable motion sensor (e.g., a vibration sensor, a thermal/infrared sensor, a proximity sensor, etc.) that is used to determine the presence of an object exterior the hub device 10 to the hub device 10 itself. The motion sensor 24 can be used to detect whether or not an object (animate or inanimate) is within the environment the hub device 10 is provided within and how close the object is to the hub device 10. The motion sensor 24 can detect, or track the movement of an object within the environment the hub device 10 is provided in.

The smoke sensor 26 and the carbon monoxide sensor 28 be used to detect the presence of smoke or carbon monoxide, respectively, within the environment that the hub device 10 is provided within. As such, the hub device 10 can be further defined as a smoke detector and/or alarm or a carbon monoxide detector and/or alarm. Similarly, the temperature and humidity sensor 32 can be used to detect or otherwise measure the temperature and/or humidity of the environment that the hub device 10 is provided within.

The camera 30 can be configured to capture a set of video recordings or pictures. The camera 30 can include any suitable camera 30 configured to capture a set of video recording or pictures in the visible or non-visible spectrum. As a non-limiting example, the camera 30 can be defined as an infrared camera 30 that can capture a set of infrared video recordings or pictures. As another non-limiting example, the camera 30 can be a defined as a visible light camera 30 that can capture a set of visible light video recordings or pictures.

The microphone 34 can be configured to capture a set of audio recordings. The microphone 34 can include any suitable microphone 34 configured to capture a set of audio recordings that are audible or non-audible to the human ear. As a non-limiting example, the microphone 34 can be, but is not limited to, a far-field microphone array. As a non-limiting example, the microphone 34 can be used to capture a verbal command spoken from a user of the hub device 10.

The scanner 36 can be configured to examine, inspect, or otherwise survey the environment exterior the hub device 10. The scanner 36 can be any suitable scanner 36 such as, but not limited to, a RADAR device, a LIDAR device, an ultrasound device, a communication scanner, or any other suitable scanning device. As a non-limiting example, the scanner 36 can be a communication scanner 36 that is configured to detect for the presence of a communication within the environment the hub device 10 is provided within. As a non-limiting example, the communication scanner 36 can scan for the presence of any suitable connection such as, but not limited to, WIFI connections, Bluetooth connections, data connections, or any combination thereof.

The set of output devices 16 can include a set of output hardware devices. As a non-limiting example, the set of output devices 16 can include the set of lights 38, a light array 40, and a speaker 42. Although only the set of lights 38, the light array 40, and the speaker 42 are illustrated, it will be appreciated that the set of output devices 16 can include any suitable output device 16 as described herein. It will be further appreciated that the set of output devices 16 can include any one or more of, or none of the output devices 16 as described herein.

The light array 40 can be configured to output a light into the environment exterior the hub device 10 such that the light array 40 is defined as a light source similar to the set of lights 38. The light array can be further defined as a set of lights (e.g., similar to the set of lights 38) that are provided in an array with respect to one another. As a non-limiting example, the lights within the light array 40 can be arranged in a circular manner such that the light array 40 is defined as a circular light array 40 or a light ring. It will be appreciated, however, that the light array 40 can be formed in any suitable shaped array. Alternatively, the light array 40 can be formed as a matrix such that the light array 40 includes one or more rows of lights or multiple light arrays. As a non-limiting example, the light array 40 can be formed around the periphery of the outer face 13 (e.g., the light array 40 can be formed as a ring around at least a portion of the periphery of the outer face 13). Further yet, it will be appreciated that the light array 40 can be included within a set of light arrays 40 provided along the hub device 10.

The speaker 42 can be configured to output an audio recording into the environment the hub device 10 is provided within. The speaker 42 can be any suitable speaker 42 configured to output an audio recording that is either audible or non-audible to the human ear.

As illustrated, the set of communication devices 18 can include a set of communication hardware device. As a non-limiting example, the set of communications devices 18 can include a WIFI module 44, a Bluetooth module 46, and a set of personal area network modules 48. As illustrated, the set of communication devices 18 includes the set of personal area network modules 48. Each personal area network module 48 can be configured to connect, pair, or otherwise exchange information with a separate personal area network. Each of the communication devices 18 can be configured to connect, pair, or otherwise exchange information with any suitable devices within range of the set of communication devices 18 and including a corresponding communication device that is suitable to communicate with the set of communication devices 18. Although only the WIFI module 44, the Bluetooth module 46, and the set of personal area network modules 48 are illustrated, it will be appreciated that the set of communication devices 18 can include any suitable communication device 18 as described herein. It will be further appreciated that the set of communication devices 18 can include any one or more of, or none of the communication devices 18 as described herein.

As illustrated, the hub device 10 can further include a controller module 22. The controller module 22 can include one or more processors 56 and a memory 58. The one or more processors 56 can be any suitable processing device, including, but not limited to, a processor core, a microprocessor, an Application Specific Integrated Circuit (ASIC), a Field Programmable Gate Array (FPGA), a controller, a microcontroller, a controller module, or the like. In another non-limiting example, the one or more processors 56 can include of processors or processor execution cores that are operatively connected. The memory 58 can include one or more non-transitory computer-readable storage mediums, such as RAM, ROM, EEPROM, EPROM, flash memory devices, magnetic disks, the like, or a combination thereof. The processor 56 and the memory 58, together, can supply the capability for the hub device 10 to properly operate the set of input devices 14, the set of output devices 16, and the set of communications devices 18.

The memory 58 can also store or otherwise have access to one or more sets of hub data as described herein. Although illustrated within the interior 20, it will be appreciated that the controller module 22, or at least a portion of the controller module can be accessible to the hub device 10. As such, at least a portion of the controller module 22 can be provided exterior the hub device 10. It is contemplated that at least a portion of the controller module 22 can be defined by or otherwise have access a server-based storage or the internet. As such the controller module 22 can access the server-based storage to obtain information related to the hub device 10 or the environment that the hub device 10 is provided within. As a non-limiting example, the memory 58 can be defined as a server-based storage such that the memory 58 of the controller module 22 is accessible to the hub device 10 even though the memory 58 is exterior the hub device 10.

The memory 58 can further include a set of software for the at least a portion of the set of input device 14, the set of output device 16, and the set of communication devices 18. It will be appreciated that at least a portion of the software is loaded onto the memory 58 prior to installation of the hub device 10. This software is defined as preloaded software. Further, it will be appreciated that the preloaded software can be added onto or otherwise edited after installation of the hub device 10. This software is defined as additional or downloaded software. As a non-limiting example, the memory 58 can include or otherwise have access to embedded software for at least one of the set of input devices 14, the set of output devices 16, or the set of communication devices 18. The embedded software can be defined as a set of software that is pre-loaded or otherwise present on the hub device 10 that allows the one or more hardware devices of the hub device 10 to function without having to first connect the hub device 10 to an external network (e.g., a wireless network). As a non-limiting example, the memory 58 can include or otherwise have access embedded software for the smoke sensor 26 or the CO sensor 28, which can be used for the operation of the smoke sensor 26 and the CO sensor 28. In other words, the hub device 10 can act as a smoke detector and/or alarm, or a CO sensor and/or alarm without needing to first connect to an external network.

The hub device 10 can include or otherwise have access to hot word software. As used herein, the term “hot word” or iterations thereof can be defined as a trigger or a set of triggers that hub device 10 can listen for (e.g., through the microphone 34), or watch for (e.g., through the camera 30) and cause the operation of at least a portion of the hub device 10 when at least one trigger is detected. It will be appreciated that the terms hot word and trigger, as used herein, can both refer to the same thing. As a non-limiting example, the microphone 34 can detect a specific digital acoustic profile that corresponds to a trigger. The hot word software can recognize this trigger and use the controller module 22 to send out a command to at least one of the input devices 14, the output devices 16, or the communication devices 18. It is contemplated that the hot word software can be defined as an embedded hot word software (e.g. ,the hub device 10 can listen for a hot word or trigger without the need to first connect to an external network). Alternatively, the hot word software can be dependent on an external network.

As a non-limiting example, the memory 58 can include or otherwise have access to programming software for at least one of the set of input devices 14, the set of output devices 16, or the set of communication devices 18. The programming software can be used to allow for a user (e.g., a developer) of the hub device 10 to reprogram or otherwise access the hardware functions of the hub device 10. As such, a user can utilize the programming software to reprogram the hub device 10 such that it can be used how they desire it to be used. As a non-limiting example, a user can utilize the programming software to create an application on a user's phone that would project a video or audio recording from the hub device 10 onto the user's phone when an object (animate or inanimate) is detected by the motion sensor 24.

As a non-limiting example, the memory 58 can include or otherwise have access to Operating System (OS) software, which can define the O/S for the hub device 10. The OS software can be any suitable software such as, but not limited to, a batch OS, a multitasking or time-sharing OS, a multiprocessing OS, a real time OS, a distrusted OS, a network OS, or a mobile OS. The OS software can be used to support basic functions of the hub device 10 such as, but not limited to, scheduling tasks (e.g., scheduling operation times for at least one of the hardware devices), controlling various portions of the hub device 10, or executing applications on the hub device 10. As a non-limiting example, the OS software can be used to execute a marketplace application accessible to or stored on the memory 58. The marketplace application can be used to buy, download, upload, or otherwise obtain additional applications that can be saved or otherwise executed on the hub device 10. As a non-limiting example, the additional applications can be used to add or otherwise redefine at least one hardware function of the hub device 10.

As a non-limiting example, the memory 58 can include or otherwise have access to at least one intelligent software that can be used for at least one of the set of input devices 14, the set of output devices 16, the set of communication devices 18, or the controller module 22. As a non-limiting example, the intelligent software can include, but is not limited to, an Artificial Intelligence (AI) software, Artificial Neural Network (ANN) software, an Expert Diagnostic System (EDS) software, a pattern recognition software, or any combination thereof. As such, the hub device 10 can be defined as an intelligent hub device 10. As a non-limiting example, a user of the hub device 10 can utilize the hub device 10 as an AI device. The user could ask it a question and the hub device 10 could, by connecting the internet through the communication devices 18, determine an answer to the user's question. The hub device 10 could then use one or more output devices 16 to communicate said answer to the user.

As illustrated, the controller module 22 can be communicatively coupled to the set of input devices 14, the set of output devices 16, and the set of communication devices 18. It is contemplated that the controller module 22 can receive hub data from, send hub data to, or otherwise send commands to or between any of the set of the set of input devices 14, the set of output devices 16, or the set of communication devices 18.

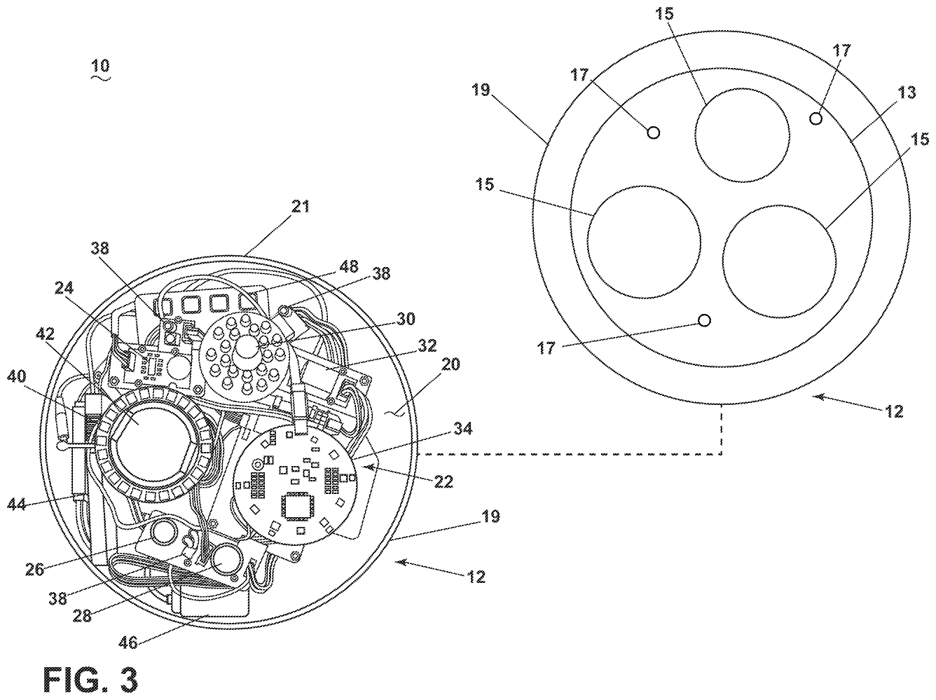

FIG. 3 is a schematic exploded view of the hub device 10 of FIG. 1 including at least a portion of the set of input devices 14, the set of output devices 16, and the set of communication devices 18. As illustrated, at least a portion of the set of input devices 14, the set of output devices 16, and the set of communication devices 18 can be packed within the interior 20 of the casing 12. Although only a portion of the set of input devices 14, the set of output devices 16, and the set of communication devices 18 are illustrated, it will be appreciated that any of the set of input devices 14, the set of output devices 16, and the set of communication devices 18 as described herein can be included within or otherwise be accessible to the hub device 10.

As illustrated, the set of input devices 14 can include, but are not limited to, the motion sensor 24, the smoke sensor 26, the Carbon Monoxide (CO) sensor 28, the camera 30, the temperature and humidity sensor 32, and the microphone 34. As illustrated, the set of output devices 16 can include, but are not limited to, the set of lights 38, the light array 40, and the speaker 42. As illustrated, the set of communication devices 18 can be defined as any device configured to receive and transmit communications over a wireless mesh network such as, but not limited to, WiFi, Bluetooth or any other suitable wireless mesh network. The set of communication devices 18 can include but are not limited to, the WIFI module 44, the Bluetooth module 46, and a personal area network modules 48 of the set of personal area network modules 48.

It will be appreciated that the controller module 22, or the memory 10 of the controller module 22, includes preloaded or existing software that allows the hub device 10 to utilize and communicate with the set of input devices 14, the set of output devices 16 and the set of communication devices 18 according to a set of functions. As a non-limiting example, the set of functions can include monitoring for smoke. In that case, the preloaded software enables the hub device 10 or the controller module 22 of the hub device to monitor the readings from the smoke sensor 26. Once a predetermined threshold value (determined via the preloaded software) is reached indicative of the presence of smoke, the controller module 22 can send a command to, for example, an output device 16 to warn a user of the hub device 10 that smoke has been detected. As a non-limiting example, the set of preloaded software can include a set of protocols or instructions of how to communicate with other devices (e.g., external devices such as a user's phone, lights, etc.). These instructions can, for example, include utilizing one or more communication device 18. For example, if an external device communicates over a certain wireless mesh network. The hub device 10 can determine the which wireless mesh network the external device is communicating over and use a respective communication device of the set of communication devices 18 to communicate directly to the external device over the wireless mesh network that the external device is able to communicate over.

The casing 12 can include an upper casing 19 and a lower casing 21. The upper casing 19 and the lower casing 21 can be selectively removable from one another. Alternatively, the upper casing 19 and the lower casing 21 can be formed as a unitary piece or otherwise operatively coupled to one another through any suitable coupling method such as, but not limited to, welding, adhesion, fastening, a snap-fit connection, clamping, or any combination thereof. Together, the upper casing 19 and the lower casing 21 can define the interior 20.

The casing 12 can include a set of openings. As a non-limiting example, the casing 12 can include a first set of openings 15 and a second set of openings 17. The first set of openings 15 and the second set of openings 17 can be configured to receive or overly at least a portion of the set of input devices 14, the set of output devices 16, or the set of communication devices 18. As a non-limiting example, one of the first openings 15 of the first set of openings 15 can overly the light array 40 and the speaker 42 such that the light emitted from the light array 40, and audio emitted from the speaker 42 can be transmitted through the first opening 15 and directly into the environment that the hub device 10 is provided within. As a non-limiting example, another of the first openings 15 of the set of first openings 15 can overly the microphone 34 such that the microphone 34 can have a clear, unimpeded path to the environment the hub device 10 is provided within such that the microphone 34 can record, or obtain clear, unimpeded audio recordings. As a non-limiting example, another first opening 15 of the set of openings 15 can overly the camera 30 such that the camera 30, similar to the microphone 34, can have an unimpeded, clear view of the environment the hub device 10 is provide within. This, in turn, ensures that the camera 30 can capture clear, unimpeded visual recordings or pictures. As a non-limiting example, the set of second openings 17 can overly the set of lights 38 such that the set of lights 38 can extend through or otherwise be able to emit light through the set of second openings 17. It will be appreciated that there can be any number of one or more first openings 15, and second openings 17. There can no first openings 15, or second openings 17. It will be further appreciated that the set of first openings 15 and the set of second openings 17 can overly any suitable portion of the hub device 10, be sized any suitable size, be shaped any suitable shape, and be provided anywhere along the casing 12. As illustrated, the set of first openings 15 and the set of second openings 17 can all be provided on the outer face 13 of the casing 12.

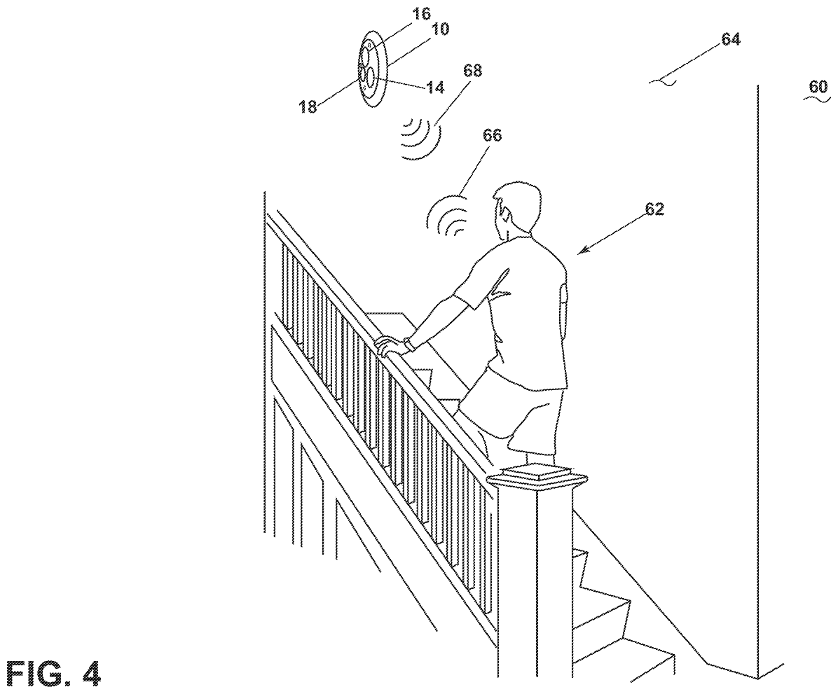

FIG. 4 is perspective view of an environment 60 including the hub device 10 of FIG. 1. The environment 60 can be any suitable environment 60 in which a user 62 can communicate with, or otherwise operate the hub device 10. As illustrated, the environment 60 can be a stairway, and the hub device 10 can be mounted to a wall 64 of the stairway. Although a stairway is illustrated, it will be appreciated that the environment 60 can be any suitable environment 60 such as, but not limited to, a room within a house (e.g., a kitchen, a living room, a bathroom, a bedroom, a hallway, a stairway, etc.) a room with a commercial environment (e.g., a showroom, a factory, a warehouse, etc.), a professional environment (e.g., an office, a meeting room, etc.), an educational environment (e.g., a classroom, a museum, etc.), or any other suitable environment 60.

The hub device 10 can be mounted to the wall 64 through any suitable mounting method such as, but not limited to, adhesion, fastening, clamping, welding, hanging or any combination thereof. Alternatively, the hub device 10 can be placed on a surface within the environment 60 such as, but not limited to, a ceiling, a table, a floor, a shelf, or any other suitable surface. It is contemplated that the hub device 10 can be located within any environment 60 in which the hub device 10 can receive an adequate power supply. As a non-limiting example, the power supply can be coupled to the hub device through a cord, or a wire. Alternatively, the hub device 10 can receive wireless power (e.g., through Near Field Communication (NFC)), or include an internal power supply such as, but not limited to, solar power, or battery power.

In operation of the hub device 10, the hub device 10 can be configured to receive an input communication 66 through at least one of the set of input device 14 to define at least a portion of the hub data as described herein. As such, the input communication 66 an define an input to the hub device 10. Based on the type of input that the input communication 66 is, the hub device 10, via the controller module 22 (FIG. 2), can generate an appropriate response and output an output communication 68 through at least one of the set of output devices 16.

As a non-limiting example, the input communication 66 can be a verbal communication (e.g., speaking, clapping, snapping, etc.) or physical communication (e.g., waving, walking, running, blinking, looking, etc.) from the user 62 containing at least one hot word. The verbal communication including the at least one hot word can be received by the set of input devices 14 (e.g., the microphone 34 of FIG. 2). The verbal communication can be defined as a portion of the hub data which is sent from the input device 14 to the controller module 22. As the controller module 22 has access to the embedded hot word software, the controller module 22 can recognize the hot word and send at least one command to at least one of the set of input devices 14, the set of output devices 16, or the set of communication devices 18. As a non-limiting example, the controller module 22 can send one command to the set of lights 38 (FIG. 2) or the light array 40 (FIG. 2) to light up or otherwise emit light, and another command to the microphone 34 to continue listening for additional, subsequent input communications 66. The emission of light from at least one of the set of lights 38 or the light array 40 can indicate to the user 62 that the hub device 10 is listening and waiting for additional input communications 66 from the user 62. It will be appreciated that the initial input communication 66 does not have to include the hot word. As a non-limiting example, the hub device 10 can be always listening and respond the input communication 66 without the hot word when one is detected. The user 62 can then send additional input communications 66 with or without the hot word as the hot word has already been detected and the hub device 10 is actively listening for further input communications 66. Additional input communications 66 can include, but are not limited to, a command or a request. In other words, the input communication 66 can include a command or a request to perform a certain hardware function of the hub device. As a non-limiting example, the input communication 66 can include a demand from the user 62 to play music. The hub device 10 can then determine an appropriate response and generate the output communication 68. In some instances, the hub device 10 can require to obtain information from the internet or an exterior memory. In such a case, the hub device 10 can send a command to at least one of the communication devices 18 to send out an output communication 68 containing a request information from memory that is exterior the hub device 10 (e.g., a webpage, an external memory on a user's phone, a memory from another hub device 10, etc.). The requested information can be returned to the communication device 18 and define an additional input communication 68.

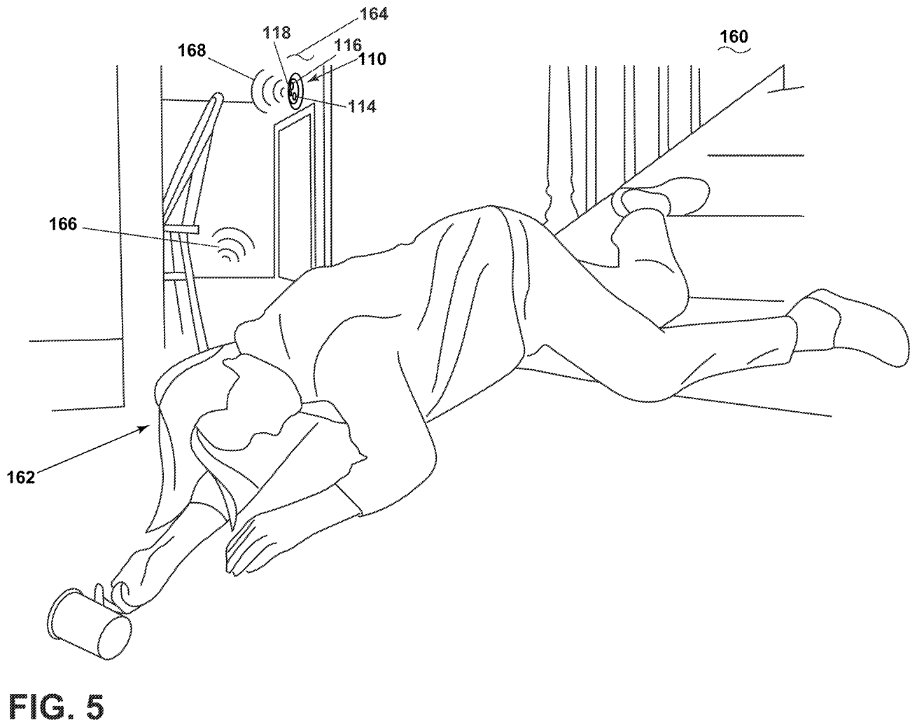

FIG. 5 is perspective view of an exemplary environment 160 including an exemplary hub device 110. The exemplary hub device 110 is similar to the hub device 10; therefore, like parts will be identified with like numerals in the 100 series, with it being understood that the description of the like parts of the hub device 10 applies to the hub device 110 unless otherwise noted.

The hub device 110 is similar to the hub device 10 in that it includes a set of input devices 114, a set of output devices 116, and a set of communication devices 118. The set of input devices 114 can include any suitable input device 114 as described herein. The set of output devices 116 can include any suitable output device 116 as described herein. The set of communication devices 118 can include any suitable communication device 118 as described herein. As illustrated, the hub device 110 can be mounted to a wall 164 of the environment 160 similar to the hub device 10, however, it will be appreciated that he hub device 110 can be mounted to, positioned on, or located within any suitable portion of the environment 160. The hub device 110, similar to the hub device 10, can be configured to receive an input communication 166 with or without a hot word or trigger, and output a corresponding output communication 168. The input communication 166 can be received by at least one of the set of input devices 114 or the set of communication devices 118. The output communication 168 can be generated through at least one of the set of input devices 114, the set of output devices 116, or the set of communication devices 118. Similar to the environment 60, the environment 160 can be any suitable environment 160 as described herein. The environment 160, as illustrated, is a residential environment 160 (e.g., a room within a house).

The input communication 166 is similar to the input communication 66 in that it is a verbal communication or a physical communication from a user 162. As illustrated, the user 162 has fallen and cannot get up or is otherwise injured. In other words, the environment 160 can be defined as an emergency environment 160 including an emergency (e.g., the user 162 falling). The user 162, through the act of falling (e.g., a physical communication) or through a verbal communication, can request, through the input communication 166, that the hub device 110 call for help. It will be appreciated that the trigger that starts the operation of the hub device 110 can be the act of the user falling or moving within a line of sight of the hub device 110, or otherwise the user 162 calling out to the hub device 110 with or without a hot word. In either case, the hub device 110 can receive the input communication 166 and determine, through the controller module 22 (FIG. 2), how to appropriately respond. As a non-limiting example, the hub device 110 can generate the output communication 168 as an attempt to contact an emergency service. As a non-limiting example, the attempt to contact can be a request sent through the internet, a request sent through a data network, a text message, a fax, or a phone call. In the case of a phone call, it is contemplated that the hub device 110 can act as a relay for a telephone (e.g., a landline within the environment 160 or a user's cellular phone). As such, the hub device 110 can continue to receive input communications 166 from the user and generate output communications 168 to whoever is on the phone call through use of at least the microphone 34 and the speaker 42. In other words, the hub device 110 can take and make phone calls.

As another non-limiting example, the hub device 110 can do something other than contacting an emergency service. As a non-limiting example, the hub device 110 can activate another input device 114, output device 116 or communication device 118 in response to the emergency environment 160. As a non-limiting example, the hub device 110 can generate an alarm through the speaker 42, produce a strobe or other light function through the set of lights 38 or the light array 40 in response to the detection of an emergency (e.g., the user 162 falling). It will be further appreciated that the environment 160 as described herein does not have to be an emergency environment 160. As a non-limiting example, the user 162 can simply request, through the input communication 166, that the hub device 110 make a phone call. The hub device 110 can then act as a relay and use the microphone 34 and speaker 42 to generate the phone call.

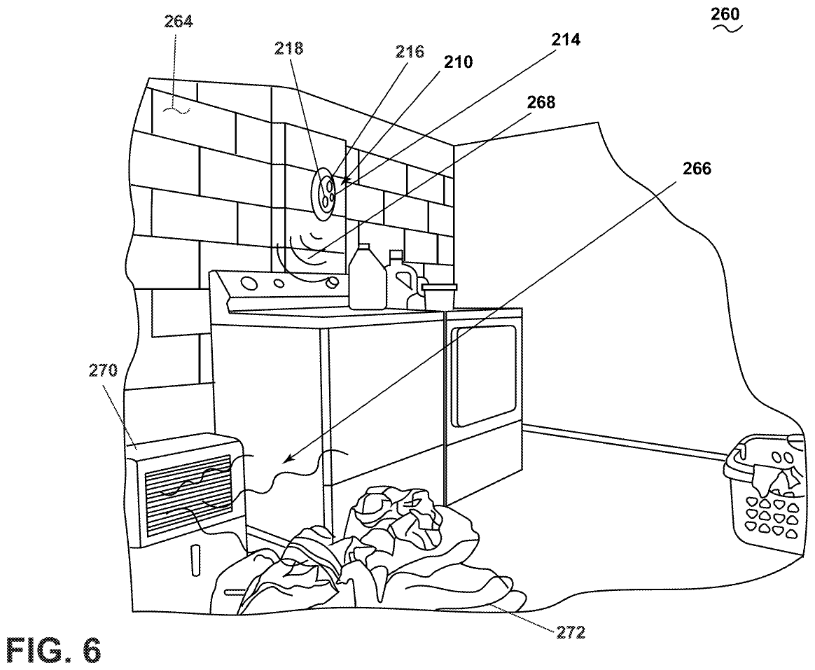

FIG. 6 is a perspective view of an exemplary environment 260 including an exemplary hub device 210. The exemplary hub device 210 is similar to the hub device 10, 110; therefore, like parts will be identified with like numerals in the 200 series, with it being understood that the description of the like parts of the hub device 10, 110 applies to the hub device 210 unless otherwise noted.

The hub device 210 is similar to the hub device 10, 110 in that it includes a set of input devices 214, a set of output devices 216, and a set of communication devices 218. The set of input devices 214 can include any suitable input device 214 as described herein. The set of output devices 216 can include any suitable output device 216 as described herein. The set of communication devices 218 can include any suitable communication device 218 as described herein. As illustrated, the hub device 210 can be mounted to a wall 264 of the environment 260 similar to the hub device 10, 110, however, it will be appreciated that he hub device 210 can be mounted to, positioned on, or located within any suitable portion of the environment 260. The hub device 210, similar to the hub device 10, 110, can be configured to receive an input communication 266 with or without a hot word or trigger, and output a corresponding output communication 268. The input communication 266 can be received by at least one of the set of input devices 214 or the set of communication devices 218. The output communication 268 can be generate through at least one of the set of input devices 214, the set of output devices 216, or the set of communication devices 218. Similar to the environment 60, 160, the environment 260 can be any suitable environment 260 as described herein. The environment 260, as illustrated, is a residential environment 260 (e.g., a laundry room within a house).

The input communication 266 differs from the input communication 66, 166, in that the input communication 266 is from a first object 270 provided within the environment 260 that is not a user (e.g., the user 62, 162). As illustrated, the first object 270 can be a space heater. The input communication 266 can be a function or an output of the first object 270. As a non-limiting example, the input communication 266 can be a heat from the first object 270. With the input communication 266, the hub device 210 can determine the temperature of the heat from the first object 270. As a non-liming example, the hub device 210 can utilize the temperature sensor 32 (FIG. 2) to measure the temperature of the heat emitted from the first object 270. The hub device 210 can then relay this information through at least one of the output devices 216 or the communication devices 218. As a non-limiting example, the hub device 210 can send the temperature to a user's phone through the Bluetooth module 46 (FIG. 2) such that the user can get an update as to the heat being emitted from the first object 270. Alternatively, the hub device 210 can utilize the set of lights 38 (FIG. 2), the light array (FIG. 2), or the speaker 42 (FIG. 2), to indicate the temperature of the heat being emitted from the first object 270.

The environment 260 can further include a second object 272 positioned proximate or adjacent to the first object 270. As illustrated, the second object 272 can be a pile of clothing. It will be appreciated, however, that the second object 272 can be any other object within the environment 260. The hub device 210 can determine the presence of both the first object 270 and the second object 272 through one or more of the input devices 214 (e.g., through the scanners 36, camera 30 or microphone 34 of FIG. 2). Alternatively, the hub device 210 can be told that the first object 270 and the second object 272 are within the environment 260 (e.g., a user can tell the hub device 210 that the objects 270, 272 are there, the user can use their phone to communicate to the hub device 210 that the objects 270, 272 are there, or the user can use a physical input on the hub device 210 to indicate to the hub device that the objects 270, 272 are there).

In any case, the hub device 210 can detect that both the first object 270 and the second object 272 are within the environment 260. The hub device 210 can further determine at least one characteristic of the first object 270 or the second object 272 through at least one of the input devices 214, controller module 22, or communication devices 218 (FIG. 2). As a non-limiting example, the hub device 210 can recognize through object-recognition software that the second object 272 is a pile of clothing by analyzing an image or video of the second object 272 generated or captured by the camera 30. The controller module 22 can then retrieve from memory 58 (FIG. 2) the characteristics of the second object 272. As a non-limiting example, the characteristics of the first object 270 or the second object 272 can include a material property of the first object 270 or the second object 272. The hub device 210 can then monitor or look for the input communication 266 from the first object 270 corresponding to a heat emitted from the first object 270. If it is determined that the heat emitted from the first object 270 exceeds a maximum threshold of a material property corresponding to a temperature that the second object 272 would burn at, then the hub device 210 could determine that a threat is present within the environment 260. The threat, in this case, being that the heat emitted from the first object 270 may burn the second object 272. The hub device 210 can then generate a command, through the controller module 22, for at least one of the input devices 214, the output devices 216, or the communication devices 218 to seek emergency services or otherwise notify a user to the potential threat, similar to the hub device 110.

It is contemplated that the hub device 210 can be used to measure various parameters of the environment 260 through the input communication 266. As a non-limiting example, the input communication 266 can be defined as a parameter of the environment 260 rather than a heat emitted from the first object 270. The parameter of the environment 260 can include, but is not limited to, a pressure, a temperature, a humidity, or any other suitable parameter of the environment 260. The hub device 210 can utilize one or more input devices 214 to receive the input communication 266 and ultimately generate an appropriate output communication 268. As a non-limiting example, the hub device 210 could relay the parameters of the environment 260 to a user device so the user could continuously monitor the parameters of the environment 260.

It will be appreciated, however, that the first object 270 or the second object 272 can be any suitable animate object (e.g., an animal) or inanimate object (e.g., an appliance) within the environment 260. As a non-limiting example, the first object 270 can be a dog within the environment 260 and the input communication 266 can be a bark from the dog (e.g., a verbal communication). As a non-limiting example, the first object 270 can be an intruding dog within the environment 260, or a dog chewing on the second object 272. In the case of the intruding dog, the input communication 266 can be the presence of the dog. In the case of the dog chewing on the second object 272, the input communication 266 can be the act of the dog chewing on the second object 272. In either case, the hub device 210 can recognize that the dog is either not supposed to be there or doing something that they are not supposed to do, and generate an output communication 268 to scare away the dog (e.g., a loud noise from the speaker 42), or to notify a user that the dog is there or is doing something that they should not be doing. While described in terms of a dog, it will be appreciated that the hub unit 210 can detect any humanoid or non-humanoid and determine whether or not they should be there or if they are causing an issue (e.g., chewing on an object) that should be told or otherwise communicated to a user or an owner of the hub device 210.

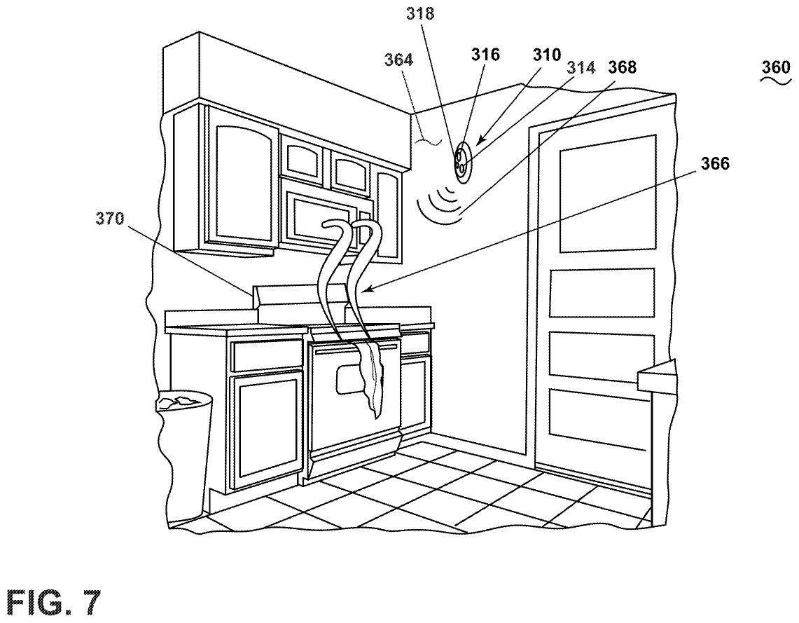

FIG. 7 is a perspective view of an exemplary environment 360 including an exemplary hub device 310. The exemplary hub device 310 is similar to the hub device 10, 110, 210; therefore, like parts will be identified with like numerals in the 300 series, with it being understood that the description of the like parts of the hub device 10, 110, 210 applies to the hub device 310 unless otherwise noted.

The hub device 310 is similar to the hub device 10, 110, 210 in that it includes a set of input devices 314, a set of output devices 316, and a set of communication devices 318. The set of input devices 314 can include any suitable input device 314 as described herein. The set of output devices 316 can include any suitable output device 316 as described herein. The set of communication devices 318 can include any suitable communication device 318 as described herein. As illustrated, the hub device 310 can be mounted to a wall 364 of the environment 360 similar to the hub device 10, 110, 210, however, it will be appreciated that he hub device 310 can be mounted to, positioned on, or located within any suitable portion of the environment 360. The hub device 310, similar to the hub device 10, 110, 210, can be configured to receive an input communication 366 with or without a hot word or trigger, and output a corresponding output communication 368. The input communication 366 can be received by at least one of the set of input devices 314 or the set of communication devices 318. The output communication 368 can be generated through at least one of the set of input devices 314, the set of output devices 316, or the set of communication devices 318. Similar to the environment 60, 160, 260, the environment 360 can be any suitable environment 360 as described herein. The environment 360, as illustrated, is a residential environment 360 (e.g., a kitchen within a house).

The environment 360 can be similar to the environment 260 in that it includes an object 370 that can generate an input communication 366. As illustrated, the object 370 is a stove or an oven. As a non-limiting example, something inside of the oven could be burning and creating a plume of smoke, which can constitute the input communication 366. The hub device 310 can receive the input communication 366 and detect the presence of smoke through the smoke sensor 26 (FIG. 2). The hub device 310, via the controller module 22, could then send a command to at least one of the set of output devices 316, or the set of communication devices 318 to produce an appropriate output communication 368 (e.g., contacting the proper emergency services, generating an alarm, strobing a light, etc.). As such, the hub device 310 can act as a fire alarm or smoke detector. It will be appreciated that the hub device 310 can be configured to sense or look for other input communications 366 from an exemplary object 370 that can be indicative of a fault of the object 370 or a threatening situation caused by the object 370. The hub device 310 can look for faults of the object 370 or threatening situations including caused by the object 370 such as, but not limited to, fire, smoke, gas (e.g., CO), vibrations, failure of the object 370 (e.g., a portion of the object 370 broke), or any combination thereof. In any case, the hub device 310 can generate an appropriate output communication 368.

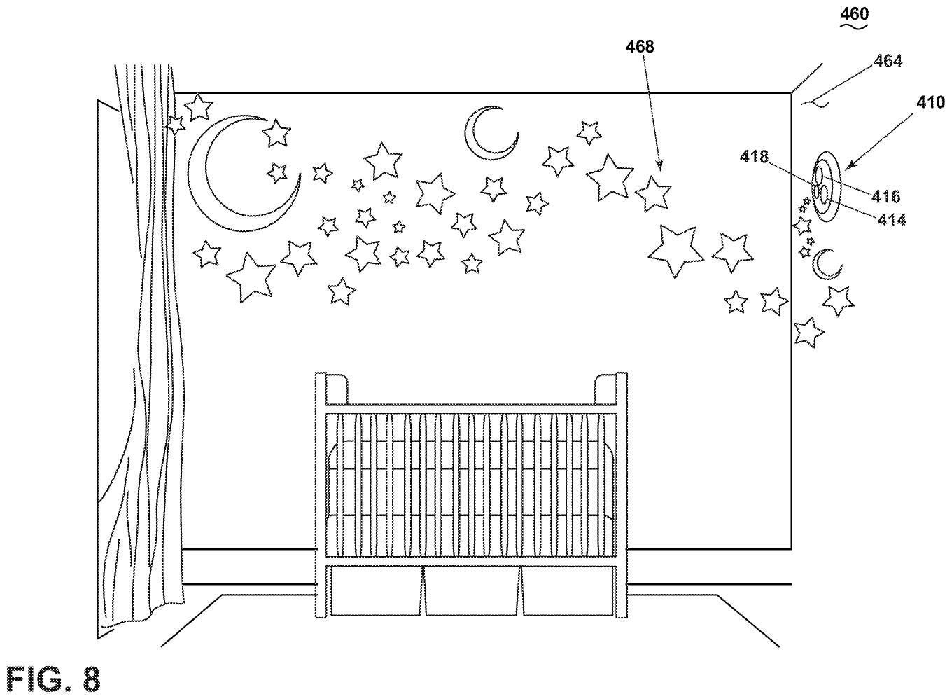

FIG. 8 is a perspective view of an exemplary environment 460 including an exemplary hub device 410. The exemplary hub device 410 is similar to the hub device 10, 110, 210, 310; therefore, like parts will be identified with like numerals in the 400 series, with it being understood that the description of the like parts of the hub device 10, 110, 210, 310 applies to the hub device 410 unless otherwise noted.

The hub device 410 is similar to the hub device 10, 110, 210, 310 in that it includes a set of input devices 414, a set of output devices 416, and a set of communication devices 418. The set of input devices 414 can include any suitable input device 414 as described herein. The set of output devices 416 can include any suitable output device 416 as described herein. The set of communication devices 418 can include any suitable communication device 418 as described herein. As illustrated, the hub device 410 can be mounted to a wall 464 of the environment 460 similar to the hub device 10, 110, 210, 310, however, it will be appreciated that he hub device 410 can be mounted to, positioned on, or located within any suitable portion of the environment 460. The hub device 410, similar to the hub device 10, 110, 210, 310, can output an output communication 468 The output communication 468 can be generated through at least one of the set of input devices 414, the set of output devices 416, or the set of communication devices 418. Similar to the environment 60, 160, 260, 360, the environment 460 can be any suitable environment 460 as described herein. The environment 460, as illustrated, is a residential environment 460 (e.g., a nursery or bedroom within a house).

The output communication 468 of the hub device 410 can be defined as a projection from the hub device 410. The output communication 468 defining the projection can be generated by one or more output devices 416 of the hub device 410. As a non-limiting example, the projection can be generated by the set of lights 38 (FIG. 2), the light array 40 (FIG. 2), or a projector within the hub device 410. As illustrated, the output communication 468 can be a projection of stars and moons on a wall of the environment 460. Although stars and moons are illustrated, it will be appreciated that the projection can take any suitable shape. As a non-limiting example, the projection can be a twinkle effect generated by the repeated operation of at least one of the lights within the light array 40 or the set of lights 38. It will be appreciated, however, that the projection can be any suitable projection such as, but not limited to, a projection of an image, a projection of a light (e.g., light from light array 40 or the set of lights 38), or a projection of a video. As such, the hub device 410 can further be defined as a projector.

The generation of the output communication 468 can be in response to an input communication (not illustrated). As a non-limiting example, the input communication can be a brightness of the environment 460 that is measured or detected by a photosensor (not illustrated) within the hub device 410. The controller module 22 can contain instructions that if the photosensor detects a brightness below a certain threshold, then the output communication 468 should be generated. As a non-limiting example, the hub device 410 can generate the projection when the environment 460 is dark or during nighttime such that the hub device 410 can act as a nightlight. Alternatively, the output communication 468 and the type of output communication 468 can be determined through input from a user, a timer (e.g., a timer within the hub device 410 such that the output communication 468 is generated during certain times of the day), a presence detector (e.g., the output communication 468 is generated when a user or object is nearby), or any other suitable input.

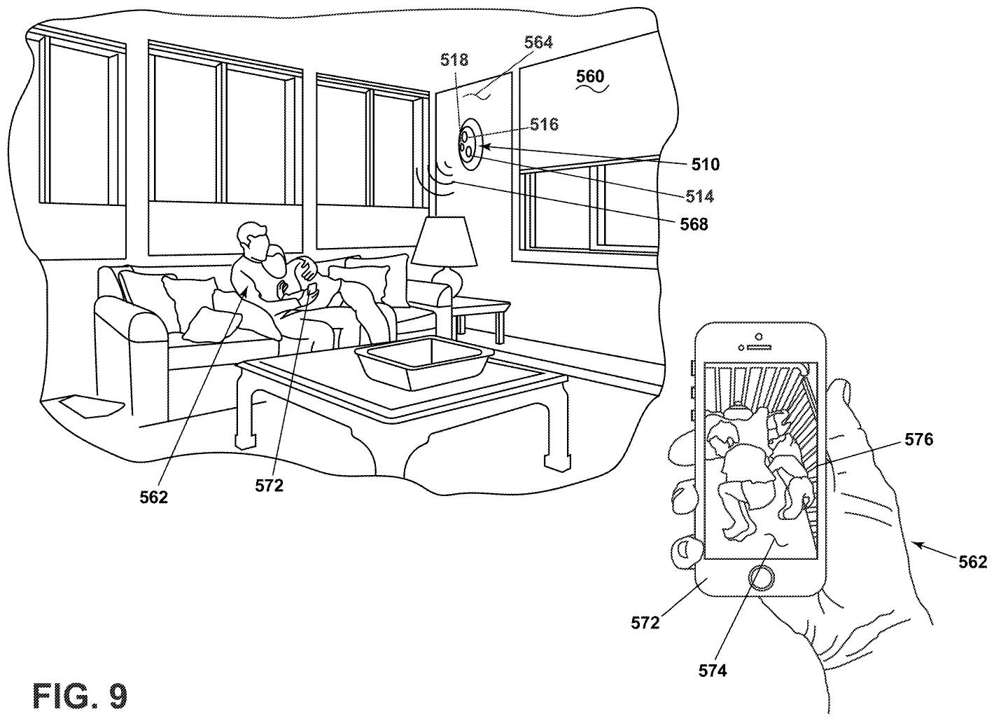

FIG. 9 is a perspective view of an exemplary environment 560 including an exemplary hub device 510. The exemplary hub device 510 is similar to the hub device 10, 110, 210, 310, 410; therefore, like parts will be identified with like numerals in the 500 series, with it being understood that the description of the like parts of the hub device 10, 110, 210, 310, 410 applies to the hub device 510 unless otherwise noted.

The hub device 510 is similar to the hub device 10, 110, 210, 310, 410 in that it includes a set of input devices 514, a set of output devices 516, and a set of communication devices 518. The set of input devices 514 can include any suitable input device 514 as described herein. The set of output devices 516 can include any suitable output device 516 as described herein. The set of communication devices 518 can include any suitable communication device 518 as described herein. As illustrated, the hub device 510 can be mounted to a wall 564 of the environment 560 similar to the hub device 10, 110, 210, 310, 410, however, it will be appreciated that he hub device 510 can be mounted to, positioned on, or located within any suitable portion of the environment 560. The hub device 510, similar to the hub device 10, 110, 210, 310, 410, can be configured to receive an input communication (not illustrated) with or without a hot word or trigger, and output a corresponding output communication 568. The input communication can be received by at least one of the set of input devices 514 or the set of communication devices 518. The output communication 568 can be generated through at least one of the set of input devices 514, the set of output devices 516, or the set of communication devices 518. Similar to the environment 60, 160, 260, 360, 460, the environment 560 can be any suitable environment 560 as described herein. The environment 560, as illustrated, is a residential environment 560 (e.g., a living room within a house).

Similar to the hub device 410, the hub device 510 can be used to generate the output communication 568 defined by a projection. The difference being, however, that the projection or output communication 568 generated by the hub device 510 is a projection of a second environment 574 separate from the environment 560 or otherwise out of the field of view of the hub device 510. As illustrated, the hub device 510 can generate the output communication 568, which is relayed to a user device 572 operated by a user 562. The user device 572 can include a display 576 to display the output communication 568 to the user 562. The user device 572 can further be any suitable user device 572 that includes a corresponding communication device that can pair, connect with, or otherwise transfer data between the hub device 510 through the communication devices 518, or otherwise be coupled to the hub device through a wired coupling (e.g., an ethernet cord). As a non-limiting example, the user device 572 can include a Bluetooth module that can pair with the Bluetooth module 46 (FIG. 2) of the hub device 510. Alternatively, the user device 572 and the hub device 510 can both include a WIFI module (e.g., WIFI module 44 of FIG. 2) such that the user device 572 and the hub device 510 can communicate with one another through a WIFI network within the environment 560. The user device 572 can be any suitable user device 572 including a display 576 such as, but not limited to, a phone, a tablet, a smartphone, a computer, a kiosk, a television, or any other suitable user device 572 that is able to communicate with the hub device 510 as described herein.

As a non-limiting example, the output communication 568 from the hub device 510 can be a real-time or prerecorded feed (e.g., a real-time or prerecorded stream of video) or picture from the second environment 574. The output communication 568 can be received by the user device 572 and displayed on the display 576 such that the user 562 can then view the real-time feed or picture of the second environment 574 on their user device 572. It is contemplated that the real-time feed or picture of the second environment can be captured via an external device within the second environment 574 (e.g., a camera within the second environment 574) or via a second hub device similar to the hub device 510 but provided within the second environment 574 or having a field of view of the second environment 574. With the latter, the second hub device can capture a video of picture with a camera (e.g., camera 30) and generate an output communication similar to the output communication 568. The output communication from the second hub device can define the input communication to the hub device 510. The hub device 510 can then relay the input communication to the user device 572. This transfer of hub data (e.g., the transfer of the video or pictures captured by the second hub device to the hub device 510) can be done through the communication of the communication devices 518 within each respective hub device 510. As a non-limiting example, each hub device 510 can be connected to the same WIFI network such that the hub devices 510 can use their respective WIFI module 44 (FIG. 2) to transfer the hub data. As a non-limiting example, the real-time or prerecorded feed or picture can be retrieved from a server-based storage. In other words, the real-time or prerecorded feed or picture can be uploaded to a server-based storage, which the hub device 10 has access to through the communication devices 518. The hub device 510 can then retrieve the real-time or prerecorded feed or picture from the server-based storage.

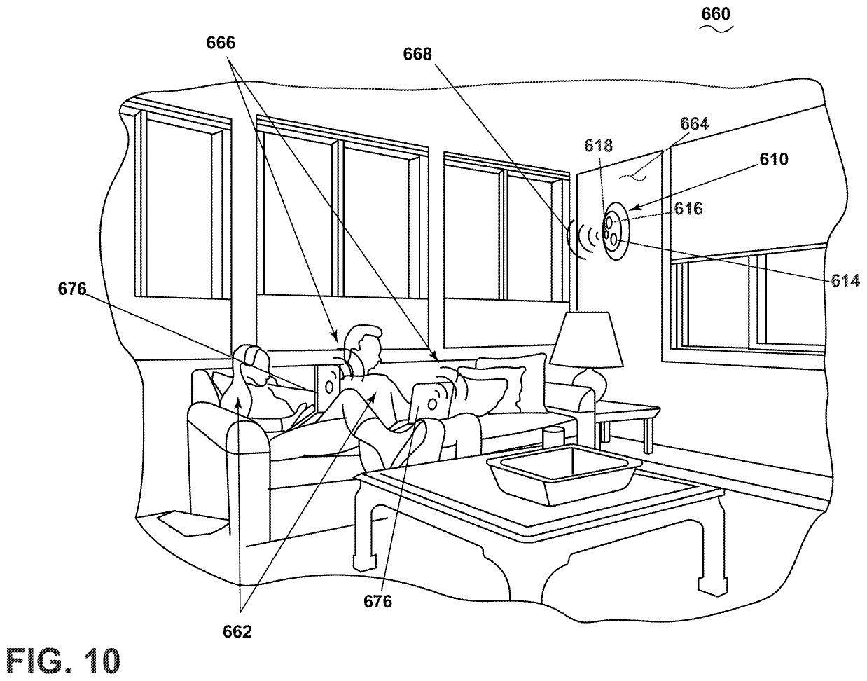

FIG. 10 is a perspective view of an exemplary environment 660 including an exemplary hub device 610. The exemplary hub device 610 is similar to the hub device 10, 110, 210, 310, 410, 510; therefore, like parts will be identified with like numerals in the 600 series, with it being understood that the description of the like parts of the hub device 10, 110, 210, 310, 410, 510 applies to the hub device 610 unless otherwise noted.

The hub device 610 is similar to the hub device 10, 110, 210, 310, 410, 510 in that it includes a set of input devices 614, a set of output devices 616, and a set of communication devices 618. The set of input devices 614 can include any suitable input device 614 as described herein. The set of output devices 616 can include any suitable output device 616 as described herein. The set of communication devices 618 can include any suitable communication device 618 as described herein. As illustrated, the hub device 610 can be mounted to a wall 664 of the environment 660 similar to the hub device 10, 110, 210, 310, 410, 510, however, it will be appreciated that he hub device 610 can be mounted to, positioned on, or located within any suitable portion of the environment 660. The hub device 610, similar to the hub device 10, 110, 210, 310, 410, 510, can be configured to receive an input communication 666 with or without a hot word or trigger, and output a corresponding output communication 668. The input communication 666 can be received by at least one of the set of input devices 614 or the set of communication devices 618. The output communication 668 can be generated through at least one of the set of input devices 614, the set of output devices 616, or the set of communication devices 618. Similar to the environment 60, 160, 260, 360, 460, 560 the environment 660 can be any suitable environment 660 as described herein. The environment 660, as illustrated, is a residential environment 660 (e.g., a living room within a house).

The environment 660 is similar to the environment 560 in that it includes at least one user 662 with a user device 676. The environment 660, however, includes a set of users 662 with each having at least one user device 676. Alternatively, the environment 660 can include one user 662, or no users 662, but still include two or more user devices 676. Input communications 666 can be generated from one or more of the user devices 676, which can result in at least one corresponding output communication 668 being generated by the hub device 610. The input communications 666 can be identical input communications 666 such that the hub device 610 can send out one output communication 668 or two identical output communication 668 to be received by the user devices 676. Alternatively, the input communications 666 can differ from each other, or only one input communication 666 from one user device 676 is sent. In either case, the hub device 610 can determine which user device 676 within the environment 660 sent the input communication 666 and make sure that the output communication is sent only to the user device 676 that sent the input communication 666. Alternatively, the hub device can send the output communication 668 to all of the user devices 676 within the environment 660.

The hub device 610 can differentiate between user devices 676 through various methods. As a non-limiting example, each user device 676 can pair with the hub device 610. As used herein, the term “pair”, “pairing”, or iterations thereof, can be defined as the establishment of a secured connection between the hub device 610 and a user device 676. Pairing can be done through any suitable method such as, but not limited to, communication via Bluetooth, WIFI, or a personal area network. When the user device 676 is initially paired with the hub device 610, the hub device 610 can assign or otherwise receive a unique identification from the user device 676. This unique identification is unique to the user device 676 and can be stored within the memory 58 (FIG. 2). This unique identification can be included within each input communication 666 from each corresponding user device 572. As such, when an input communication 666 is received by the hub device 610, the hub device 610, via the controller module 22 (FIG. 2), can read the unique identification and compare it to the unique identification in memory. If the hub device 610 does not find a match, the hub device 610 can send out an output communication to the user device 676 to initiate a pairing process. If, however, the hub device 610 does find a match, the hub device 610 will know exactly which user device 676 the input communication 666 was received from.

It is contemplated that this identification method can be used to determine which user 662 is present within the environment 660. As a non-limiting example, each user device 676 can be attributed to a certain user 662 or user profile when paring between the user device 676 and the hub device 610 occurs. When the hub device 610 receives an input communication 666 (e.g., the user device 676 can constantly or periodically emit the input communication) from the user device 676, the hub device 610 can receive the input communication 666 and determine, via the controller module 22, which user is within the environment 660. It is contempered that the hub device 610 can commit to memory at least one user preference. As a non-limiting example, the user 662 can prefer that a song play, or the hub device 610 welcome them each time they walk into the environment 660. As such, once the hub device recognizes that unique identification of the user device 676, the hub device 610 can generate an output communication 668 corresponding to the user's preference. Alternatively, the hub device 610 can recognize the user 662 without use of the user device 676. As a non-limiting example, the hub device 610 can recognize a video image, a picture, a thermal emission, a vibration, a sound, a voice, or any other suitable defining feature of the user 662 in order to determine that the user 662 is within the environment 660.

It is further contemplated that the hub device 610 can include a network relay or a network transmitter that can be used as a relay or hotspot, or otherwise define a portion of a mesh network for a wireless network. As a non-limiting example, the hub device 610 can connect to the wireless network (e.g., a WIFI or data network), and act as a relay for the user devices 676 within the environment 660. In other words, the user devices 676 can connect to the wireless network through the hub device 610. The hub device 610 can further enhance the network by transmitting a strengthened version of the wireless network through the hub device 610.

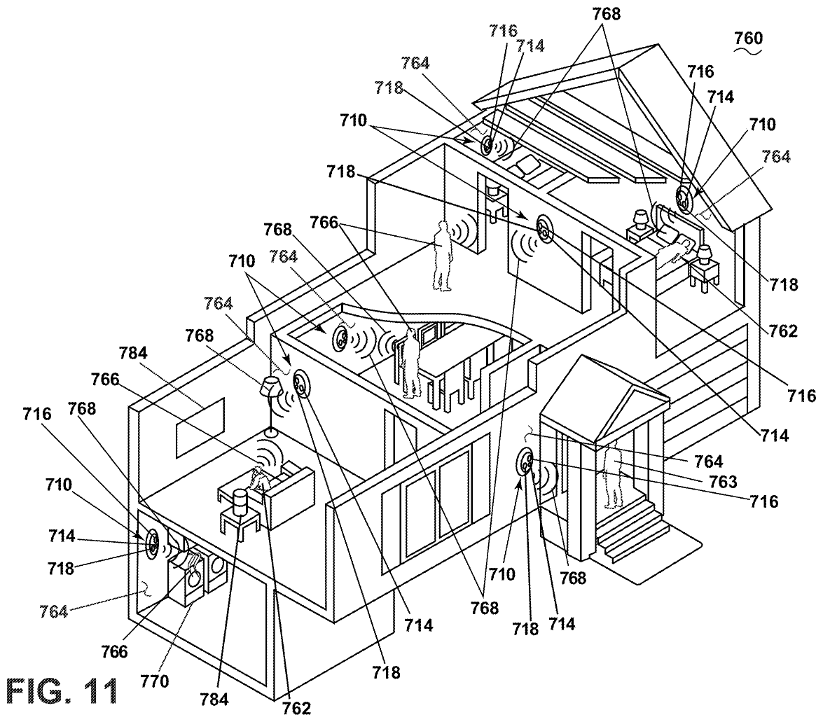

FIG. 11 is a schematic perspective view of a set of environments 760 including the set of hub devices 710 of FIG. 1. The exemplary hub device 710 is similar to the hub device 10, 110, 210, 310, 410, 510, 610; therefore, like parts will be identified with like numerals in the 700 series, with it being understood that the description of the like parts of the hub device 10, 110, 210, 310, 410, 510, 610 applies to the hub device 710 unless otherwise noted.

The set of hub device 710 are schematically illustrated. Each hub device 710 of the set of hub devices 710 is similar to the hub device 10, 110, 210, 310, 410, 510, 610 in that it includes a set of input devices (not illustrated), a set of output devices (not illustrated), and a set of communication devices (not illustrated). The set of input devices can include any suitable input device as described herein. The set of output devices can include any suitable output device as described herein. The set of communication devices can include any suitable communication device as described herein. As illustrated, each hub device 710 can be mounted to a wall 764 within each corresponding environment 760 similar to the hub device 10, 110, 210, 310, 410, 510, 610, however, it will be appreciated that he hub device 710 can be mounted to, positioned on, or located within any suitable portion of the set of environments 760. Each hub device 710, similar to the hub device 10, 110, 210, 310, 410, 510, 610, can be configured to receive an input communication 766 with or without a hot word or trigger, and output a corresponding output communication 768. The input communication 766 can be received by at least one of the set of input devices or the set of communication devices. The output communication 768 can be generated through at least one of the set of input devices , the set of output devices, or the set of communication devices. Similar to the environment 60, 160, 260, 360, 460, 560, 660, each environment 760 can be any suitable environment 760 as described herein. The set of environments 760, as illustrated, are within a residential environment 760 (e.g., a living room, a laundry room, a dining room, a front porch, and a bedroom within a house).

The set of environments 760 can include a plethora of environments 760 that would normally be found within a household. Each of the environments 760 can include at least one hub device 710 provided along at least one wall 764 of the respective environments 760. It is contemplated that each hub device 710 of the set of hub devices 710 can be connected or otherwise paired with one another through a common network (e.g., WIFI network, data network, Bluetooth, etc.). As a non-limiting example, each hub device 710 of the set of hub devices 710 can be connected to each other through their respective WIFI modules 44 (FIG. 2) that are each connected to a WIFI network that is present within the entirety of the set of environments 760. As such, the set of hub devices 710 can communicate with each other or otherwise send commands, requests, or data (e.g., the hub data) to each other.

It is contemplated that a hub device 710 in one environment 760 can receive an input communication 766 and communicate said input communication 766 to at least one other hub device 710 via an output communication 768. The output communication 768, which can then be received by the at least one other hub device 710 and define an input communication to the hub device 710 (e.g., an output communication 768 from one hub device 710 can define an input communication to another hub device 710). The at least one other hub device 710 can then generate a corresponding output communication 768 within the environment 760 it is received within, or it can generate another output communication that goes back to the original hub device 710 as another input communication 766. In such a way, the hub devices can talk to one another and communicate various parameters of the environment 760 they are located within to one another. It is contemplated that the hub device 710 can communicate via any suitable wireless or wired network. As a non-limiting example, the hub devices 710 can be connected to one another through a wired connection such that commands, requests, or data can be transferred over-wire between the hub devices 710. In either case, the set of hub devices 710 can define a network of hub device 710. It is contemplated that eh network of hub devices 710 can, together, be connected to the internet via the wireless or wired connection.

As a non-limiting example, one of the hub devices 710 within an environment 760 can include receive an input communication 766 from an object 770. As illustrated, the input communication 766 can be smoke being emitted from a laundry appliance. The hub device 710 having detected the smoke as discussed herein, can send an output communication 768 as an alarm through the hub device 710. Additionally, the hub device 710 can send an additional output communication 768 to the other hub devices 710 within the set of environments 760 with a request to also sound an alarm or indicate to one or more of the users 762 that the object 770 is emitting smoke. The other hub devices 710 can receive the request as an input communication 766 and ultimately indicate to the users 762 or sound an alarm (e.g., through the speaker 42 (FIG. 2)) to indicate to the user 762 that the object 770 is smoking. It is contemplated that each output communication 768 can further include a hub identification such that when another of the hub devices 710 receives the output communication 768 as an input communication 766, they can know which of the hub devices 710 it was received from. Each hub device 710 can commit to memory 58 (FIG. 2), the location of each hub device 710, the hardware functions of each hub device 710, and the unique identification of each hub device 710 that is connected to the common network.

As another non-limiting example, a non-identified user 763 can approach one of the hub devices 710. The hub device 710 can recognize through the input communication (e.g., video recording through the camera 30, presence detection through the motion sensor 24 (FIG. 2), etc.) that this is a non-identified user 763 is present within its field of view. Although described in terms of a non-identified user 763, it will be appreciated that this can apply to any suitable user 762 that is identified by the hub device 710. The reorganization of the non-identified user 763 can lead to the hub device 710 generating an output communication 768 to one or more of the other hub devices 710 to notify to the users 762 within at least one of the set of environments 760 that the non-identified user 763 is present.

As another non-limiting example, a user 762 within an environment 760 including an external device 784 can use the hub device 710 to control said external device 784. As illustrated, the external device 784 can also be a television. The external devices 784 can be any suitable external device 784 such as, but not limited to, a lock for a door, shades for a window, a motor (e.g., for a door such as a garage door), an appliance (e.g., a refrigerator, a blender, a stovetop, a heating system, a cooling system, a washer, a dryer, a dishwasher, a shower, etc.), an electronic device (e.g., a television, a tablet, a user device, a security system, an external speaker, an external camera, a computer, etc.), a medical device, a smart device, an AI device, or any combination thereof. The user 762 can send a request through a verbal or physical command as an input communication 766 to the nearest hub device 710 to operate the external device 784 as they want it to be operated. As a non-limiting example, the user 762 can want to turn up the volume on the external device 784, turn on the external device 784, turn off the external device 784, or otherwise change the operation or function of the external device 784. It is contemplated that the hub device 710 or the set of hub devices 710 can be previously paired with the external device 784 such that the hub device 710 has prior authorization to control the function of or otherwise send commands to the external device 784.

It is contemplated that the set of hub devices 710 can be used to perform basic functions within the set of environments 760 by connecting to one or more external devices 784. As a non-limiting example, the external device 784 can include a light, a drape, a kitchen appliance (e.g., a coffee brewer), a showerhead, a laundry appliance, or any other suitable device. The set of hub devices 710 can connect to each of these external devices 784 and operate them according to a schedule set by the user 762. As a non-limiting example, the hub device 710 can send commands to a motor that actuates (e.g., opens) the drapes or a command to the lights to turn on when the user wakes up. The set of hub devices 710 can further send a command to the coffee brewer to start brewing coffee so coffee is available to the user when they want it. The set of hub devices 710 can further send a command to the showerhead to turn on and output water at a user-preferred temperature. As such, the hub device 710 can be used to create a smart-home environment for the user 762, in which the user can optimize or otherwise define to fit their preferred schedule.

It is contemplated that the set of hub devices 710 can connect to an external device 784 defined by a medical device (not illustrated). The medical device can be any suitable medical device such as, but not limited to, a blood oximeter, a telehealth system, a scale, or any other suitable non-evasive health monitoring system. As a non-limiting example, the external device 784 can be a blood oximeter, and the hub device 710 connected to the external device 784 can help facilitate a telehealth appointment with the user's 762 doctor. As a non-limiting example, the hub device 710 can use one or more of the input devices 714, the output devices 716, or the communication devices 718 to help facilitate the telehealth appointment. As a non-limiting example, the hub device 710 can use the temperature sensor 32 (FIG. 2) to measure the user's 762 body temperature. As a non-limiting example, the hub device 710 can utilize the camera 30 (FIG. 2), to take a video recording or otherwise generate a real-time video feed of the user 762. The hub device 710 can further use the camera 30 to recognize or otherwise identify the user 762. As a non-limiting example, the hub device 710 can recognize of identify the user through any suitable method described herein, or through a face-recognition software provided on the hub device 710. The hub device 710 can connect to the user's health provider (e.g., to another hub device 710 owned by the health provider, or another device including a camera and a microphone owned by the health provider) through use of at least one of the communication devices 718 of the hub device 710. As a non-limiting example, the information gathered by the hub device 710 (e.g., the real-time video feed, user's body temperature, etc.) can be sent to the user's health provider through the hub device 710. As a non-limiting example, the hub device 710 can project an image or video of the health provider into the environment 760 the hub device 710 is provided in.

It is further contemplated that the hub device 710 can connect to an external device 784 including a security system. The security system can be defined as an external device 784 including an array of sensors or devices provided within the set of environments 760 configured to detect, detract, or notify the user of a threat (e.g., an intruder, a fire, etc.). The security system can include, but is not limited to, motion sensors, vibration sensors, cameras, microphones, speakers, magnetic sensors, or any combination thereof. As a non-limiting example, the set of environments 760 can include a set of magnetic sensors provided along various entry points (e.g., doors or windows) of the set of environments 760. The magnetic sensors can be configured to detect when the entry points have been opened or closed. The hub device 710 can connect to the magnetic sensors and determine when one or more of the entry points to the set of environments 760 had been opened or closed. The hub device 710 could then determine which entry point had been opened or closed and begin recording that area in order to identify a cause for why the entry point had been opened or closed. As a non-limiting example, the hub device 710 can use the camera 30 to record the entry point and determine why the entry point opened or closed. The hub device 710 can recognize the cause for why the entry point was opened or closed through person (e.g., facial) recognition or object recognition. If the object or person is not recognized, the hub device 710 could determine that the object or person is a threat and notify the user 762 of the hub device 710 with information relating to the threat (e.g., location, type of threat, etc.). It is further contemplated that the user 762 could set the set of hub devices 710 into a sentry mode such that the hub device 710 will notify the user 762 if any entry point is opened or close, regardless of whether or not the hub device 710 determines if the reason is a threat. As a non-limiting example, the user 762 could implement the sentry mode when they are not in the set of environments. It is further contemplated that the hub device 710 can utilize any of its input devices 714, output devices 716, or communication devices 718 in conjunction with the security system. As a non-limiting example, the hub device 710 could use its microphone 34 (FIG. 2) and sound-recognition software to detect and recognize the sound of breaking glass. As a non-limiting example, the set of hub devices 710 could use its camera 30 and recognition software (e.g., facial recognition) to determine the presence of an intruder, the identity of the intruder, or otherwise record the intruder as they move through the environment 760 or between the set of environments 760. As a non-limiting example, the hub device 710 can utilize its speaker 42 (FIG. 2) to sound an alarm or convey a message in the set of environments 760. The message, for example, can be a message to the intruder that the emergency authorities are on their way to the set of environments 760. As a non-limiting example, the hub device 710 can use its set of lights 3 (FIG. 2) to flash lights or otherwise illuminate the set of environments 760 in order to deter the intruder or otherwise illuminate the intruder. As such, the hub device 710 can be defined as a portion of the security system. It is further contemplated that the hub device 710 can define a security system. As a non-limiting example, the hub device 710 can be configured to detect an intruder (e.g., through the camera 30 or motion sensor 24 (FIG. 2)), and sound an alarm or otherwise notify the user 762 to the presence of the intruder.

As discussed herein, the set of hub devices 710 can identify one or more threats (e.g., fire, smoke, CO, intruders, foreign objects, an impending threat, etc.) within the set of environments 760. It is contemplated that the set of hub devices 710 within the set of environments 760 can form a web of hub devices 710 that are connected to one another and can communicate with one another. As such, if a threat is detected by one of the hub devices 710, the threat can be communicated to at least one other hub device 710 to notify the user 762 or otherwise take proper action (e.g., notify the proper authorities). As a non-limiting example, the set of hub devices 710 can recogniz3e which environment 760 or environments 760 has one of the users 762 present, and use the hub device 710 within the corresponding environment 760 in order to notify the user 762 that a threat has been detected. It is contemplated that the notification to the user 762 can be any suitable notification such as, but not limited to, a light, a sound, a message, or vibrate, or any combination thereof. As a non-limiting example, the set of hub devices 710 can utilize their speakers 42 to play a message to the users 762. The message, as a non-limiting example, can include information relating to the threat such as, but not limited to, a location of the threat, the type of threat, the characteristics of the threat (e.g., a temperature), or the importance of the threat. As a non-limiting example, the set of hub devices 710 can father be used to determine the presence and location of occupants (e.g., the user 762, a household pet, a baby, a visitor, etc.) within the set of environments 760 that can be harmed by the threat. The message can contain the presence and location of the users 762. The user 762, in this case, can also include a household pet or baby. This information can be sent by the users 762 to determine where they are with relation to one another, or this information can otherwise be sent to the emergency authorities. As a non-limiting example, at least a portion of the environments 760 can include a fire and an occupant. In such a case, firefighters would be called to the set of environments 760 to put out the fire and rescue the occupant. The hub devices 710 could be used to convey to the firefighters (e.g., through an audible message, a visual indicator, or a message sent to the authorities) the location of the fire and the location of the occupant.

It is contemplated that the hub device 710 can include or otherwise have access to one or more protocols of the external devices 784. As used herein, the term “protocols” or iterations thereof can refer to a set of instructions or rules that determine how data can be exchanged to and from a device. In other words, the hub device 710 can include or otherwise have access to the protocols for each external device 784 such that the hub device 710 can receive communications from and send communications (e.g., instructions or commands) to the external device 784. As such, the hub device 710 can transfer data with, or send commands to the external devices 784.

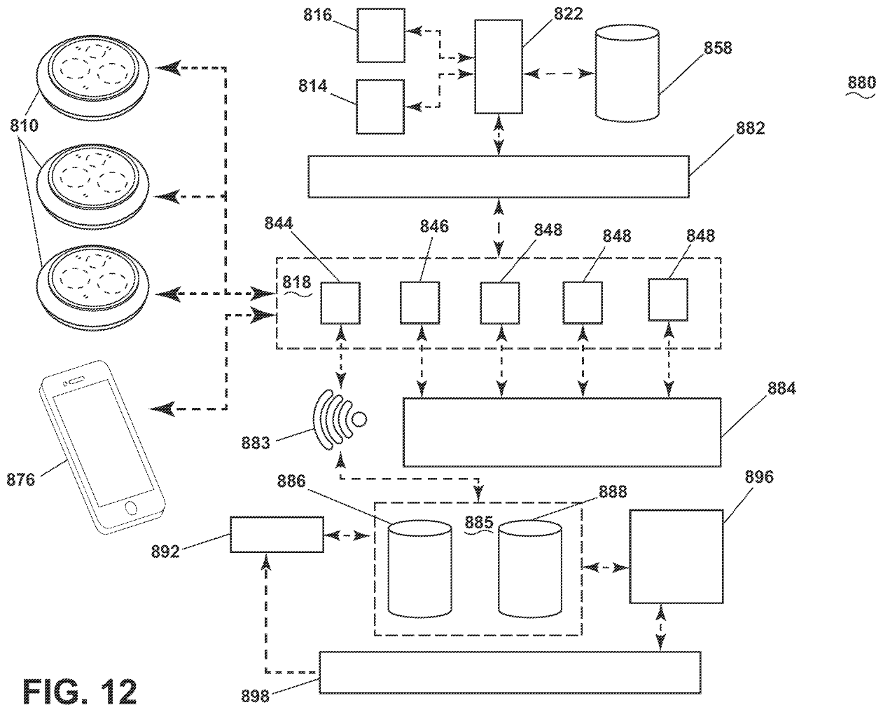

FIG. 12 is a schematic diagram of an exemplary communication environment 880 including an exemplary set of hub device 810 of FIG. 1. The exemplary hub device 810 is similar to the hub device 10, 110, 210, 310, 410, 510, 610, 710; therefore, like parts will be identified with like numerals in the 800 series, with it being understood that the description of the like parts of the hub device 10, 110, 210, 310, 410, 510, 610, 710 applies to the hub device 810 unless otherwise noted.

Each hub device 810 of the set of hub devices 810 is similar to the hub device 10, 110, 210, 310, 410, 510, 610, 710 in that it includes a set of input devices 814, a set of output devices 816, and a set of communication devices 818. The set of input devices 814 can include any suitable input device 814 as described herein. The set of output devices 816 can include any suitable output device 816 as described herein. The set of communication devices 818 can include any suitable communication device 818 as described herein. As a non-limiting example, the set of communication devices can include a WIFI module 844, a Bluetooth module 846, and a set of personal area networks 848. Each hub device 810 can further include a controller module 822 and a memory 858 accessible to the controller module 822. The memory 858 can include a set of software (e.g., embedded software, I/O software, programming software, hot word software, etc.). It will be appreciated that the illustrated communication environment 880 is a schematic representation such that various elements of the set of hub devices 810 are combined into a single illustrated element (e.g., the set of input devices 814, the set of output devices 816, the set of communication devices 818, the controller module 822, and the memory 858). It will be appreciated that each hub device 810 includes their own respective set of elements. Alternatively, one or more elements can be shared between hub devices 810. As a non-limiting example, each hub device 810 can share a single controller module 822 or memory 858, or otherwise combine each respective controller module 822 or memory 858 such that the set of hub devices 810 can be defined to have a single controller module 822 or memory 858.

Each of the hub devices 810 of the set of hub devices 810 can communicate with one another through use of their respective communication devices 818. As a non-limiting example, each communication device 810 can be connected to a local WIFI or data network such that the hub devices 810 can freely communicate with each other through the use of their WIFI modules 844. Each hub device 810 can further include a set of radios or controllers 882 corresponding to each of the WIFI modules 844, the Bluetooth modules 846, and the set of personal area networks 848. It is contemplated that each of the WIFI module 844, the Bluetooth module 846, and the set of personal area networks 848 can be governed or otherwise controlled through a corresponding communication protocol. As a non-limiting example, data received through the WIFI modules 844 would use a WIFI communication protocol, data from the Bluetooth modules 846 would use a Bluetooth communication protocol and data from the personal area networks 848 would each use their own personal area network communication protocol. In order for this data to be received by the controller module 822, or otherwise be communicated from another of the communication devices 818, the communication protocols need to be deciphered or put into a format that can be read by the destination of the data. As a non-limiting example, a set of data can be received by one of the WIFI modules 844 and need to be communicated to a user through one of the Bluetooth modules 846. The set of radios or controllers 882 can act as a gateway and convert or otherwise decipher the data from the WIFI modules 844 from the WIFI communication protocol to the Bluetooth communication protocol so that the set of data can be sent to and transmitted through the Bluetooth modules 846. As such, the set of radios and controllers 882 can be defined as a gateway between the set of. As a non-limiting example, one hub device 810 can send a request to another hub device 810 to read the temperature in the environment that the other hub device 810 is located within. The request can be sent through the communication devices 818 (wirelessly or through a wired connection) and received by the other hub device 810 where it is then converted to a computer-readable format. The controller module 822 can then determine the instructions from the original hub device 810 and send a command to the corresponding input device 814 to take a reading of the temperature of the environment. Once the temperature is read, the controller module can send the requested information back to the original hub device 810 through the communication devices 818.

The communication devices 818 can further communicate with or otherwise be paired with a set of external devices 884 or a set of user devices 876. Various requests, commands, or data can be received or sent to the set of user devices 876 as described herein (e.g., see FIGS. 6-7 and 9-10), or the set of external devices 884. As a non-limiting example, the set one of the set of external devices 884 could be a motor for an animal door that the hub device 810 has a field of view for. When the hub device 810 received an input communication that the animal is nearing and recognizes that the animal has authority to go through the door (e.g., through a microphone, camera, etc. of the hub device 810), the hub device 810 can send a command to the motor to open the animal door and close it once the animal is through the animal door.

At least one of the communication devices 818 of each hub device 810 can further be communicatively coupled to an internet connection 883. As a non-limiting example, the WIFI modules 844 can be communicatively coupled to the internet connection or internet connection 883.

The internet connection 883 can have access to a user memory 885 including user data 886. The user data 886 can be include any suitable data relating to the use of the set of hub devices 810 corresponding to the user of the user device 876. As a non-limiting example, the user data 886 can include any suitable data such as, but not limited to, user information (e.g., the name, address, age, location, etc. of the user), the identity of the hub devices 810 within their network (e.g., the identity of the hub devices within the communication environment 880), the hardware devices within the hub devices 810, the user of the hub devices 810, any of the hub data collected or generated by the hub devices 810, or any combination thereof. In other words, the user memory 885 can include all data corresponding to the hardware functions (e.g., which hardware is being used, how often it is being used, how it is being used, who is using it, etc.) of each hub device 810 of the set of hub devices 810. As such, the internet connection 883 can act as a portal for the user of the user device 876 to view, access, or monitor their hub devices 810.

As a non-limiting example, a user can utilize the user device 876, connect to the internet connection 883, and open up an application for the hub device 810 that can connect to the set of hub devices 710 through the internet connection 883. As a non-limiting example, the application can be a hub application 892 or a developer tools 896. Both can be used by a user of the application to control the set of hub device 810, however, the developer tools 896 can be used to reprogram the set of hub devices 810 or create additional hub applications 892. The internet connection can be used to connect the applications to the set of hub devices 810 or the user device. It will be appreciated, however, that at least one of the applications does not need to utilize the internet connection 883 in order to connect to at least one of the user device or the set of hub devices 810. As a non-limiting example, the applications can connect to the set of hub devices 810 through a Bluetooth connection.

The hub application 892 can be used to access the user memory 885, send requests or commands to the hub devices 810, receive or view communications from the hub devices 810, or share hub data between hub devices 810 or other users. As a non-limiting example, the user of the user device 876 can utilize the hub application 892 to send a command to the hub device to perform a certain hardware function (e.g., play music, record video, illuminate an environment, etc.).

It is further contemplated that the communication environment 880 can be used as a programming environment for the set of hub devices 810. As such, the internet connection 883 can further have access to or otherwise include the user memory 885 including additional user data 888. The additional user data 888 can be similar to the user data 886, however, the additional user data 888 can include user data for a set of users and multiple sets of hub devices 810 (e.g., sets of hub devices 810 within different environments) rather than just a single user or a single set of hub devices 810. The additional user data 888 can be actual user data from actual use of the corresponding set of hub devices 810, or the additional user data 888 can be non-real-world data (e.g., data that is made up, fake, or otherwise not real). In either case, the additional data can be used in a programming environment to simulate the function and operation of the set of hub devices 810, or multiple sets of real world or non-real-world hub devices 810. The set of user data 886 and the set of additional user data 888 can be at least one of real-world data (e.g., data gathered by a hub device 810 that is in use within an environment) or a synthetic data (e.g., data that is arbitrarily input or made up by a user of the developer tool).

At least a portion of the user data 886 and the additional user data 888 can be used or otherwise accessed through the developer tools 896. The developer tools 896 can be used by a user of the user device in order to develop, run, simulate, upload, or edit an application that can ultimately be run by at least one of the set of hub devices 810. In other words, the developer tools 896 can be used to, among other things, create the hub application 892 that can run on the set of hub devices 810 or the user device 876. The developer tools 896 can include a set of tools that the developer (e.g., user) can utilize in order to develop, run, simulate, upload, and edit the application. As a non-limiting example, a developer can utilize the developer tools 896 to create an application that will work with the specifications of the set of hub devices 810 and the user device 876. The developer can create the application, and then simulate the running of the application through the use of the developer tools 896. The developer can further simulate the operation of a hub device 810 or a set of hub device 810 based on the application (e.g., simulation of inputs from the set of hub devices 810, and outputs to the hub devices 810 from the application). The simulations can be, in part, based on the user data 886 or additional user data 888. In other words, the developer can simulate the operation of the hub device 810 with real-world user data.

The application created through use of the developer tools 896 can ultimately be uploaded, through the developer tools 896, to a hub portal 898 where users of the set of hub devices 810 can download the application onto their user device 876 to define the hub application 892. The hub portal 898 can include a set of applications that the user can pick and choose from in order to decide which hub application 892 or set of hub applications 892 they want to run through their user device 876 and set of hub devices 810. As each hub application 892 can alter or add onto the functionality of the set of hub devices 810, the user can decide or otherwise manipulate the functionality of their set of hub devices 810 based on which hub applications 892 they have downloaded from the hub portal 898 and are running on their user device 876 in conjunction with the set of hub devices 810. The applications 892 can contain at least one edit or addition to the preloaded software of the hub device 810. As such, the applications 892 can be defined as additional or downloaded software. It will further be appreciated that the hub portal 898 can include a set of applications or sets of data that can be used by the developer (e.g., user), through the developer tools 896, to provide additional accessibility or performance of the hub device 810. The hub portal 898 can include, but is not limited to, applications that can be run on the hub devices 810, applications that can be used to reprogram the hub device 810, hardware kits (e.g., additional hardware for the hub device 810 or external devices 884 that can be used with the hub device 810 in order to add a greater number of possible inputs, outputs or communications from the hub device 810), or software kits (e.g., a set of software that can be added to the memory 858 of the hub devices 810 and effect the function of the hub device 810). In other words, the applications and sets of data from the hub portal 898 can be used to add functionality to the hub devices 810, redefine the functionality of the hub devices 810, or otherwise run simulations of the user device 876. The simulations can be used by the user in order to develop additional applications that can be downloaded or otherwise retrieved by other users who have access to the hub portal 898.

The hardware kits can include additional hardware (e.g., external devices 884 that can define an input communication to the hub device 810, or additional input devices 814, output devices 816, or communication devices 818) that can be physically installed within, on, or otherwise connected to the hub device 810. The software kits can include a set of software (e.g., code) that can be loaded onto or otherwise saved on the memory 58 (FIG. 2), such that the hub device 810 can operate according to the software kit. The software kits and the hardware kits can work in conjunction with one another. As a non-limiting example, the hardware kit can include a third-party external device that operates on a native protocol. The software kit can include the native protocol such that the hub device 810 can connect with and communicate with the third-party external device once the software kit is installed on the hub device 810. A set of hardware kits (e.g., one or more hardware devices) and a set of software kits (e.g., one or more software packages) can be included within a single application or kit that can be uploaded by an authorized user and downloaded by a user of the hub device 810. In other words, a user can download a kit that includes both the additional software and the additional hardware. The additional hardware can automatically sent to or otherwise purchased for the user of the hub device 810. In the case where the application includes a hardware kit, the user can be prompted to buy the hardware kit and have it delivered to them or the hardware kit can automatically be purchased when the application is purchased or otherwise downloaded. The application can be run through the hub devices 810 such that the hub devices 810 can operate according to the software kit and in conjunction with the hardware kits. The user can view the application on their user device 876.

The hub portal 898 can be accessed by either a user (e.g., through the hub application 892) or by the developer (e.g., through the developer tools 896). The user can download applications from the hub portal 898, while the developer can download and upload applications to the hub portal 898. It is contemplated in order to upload applications to the hub portal, or to perform various reprogramming of the hub devices 810, that additional verification can be needed. In other words, in order to utilize the developer tools 896, the user can be vetted or otherwise verified before obtaining access to the reprogramming functions of the set of hub devices 810, or to upload applications to the hub portal 898. As a non-limiting example, the vetting can be done through a prior authorization with the hub devices 810 or the software governing the hub devices 810. Once vetted, each user can be given a unique developer identification. The request that was originally sent from the user device 876 to the communication devices 818 of the set of hub devices 810 can include the unique developer identification. Before granting access to the developer tools internet connection 883, the request can be analyzed to see if the user device 876 has permission to access the developer tools 896. As a non-limiting example, the internet connection 883 webpage can access a memory with the unique developer identifications that have granted access to the developer tools 896 saved to determine whether or not the unique developer identification matches any of the unique developer identifications that have prior authorization for the developer tools 896. If it is determined that they do, then the developer tools 896 and the hub portal 898 can be displayed through the user device 876.

It is contemplated that a developer could use the developer tools 896 to create an application for the hub device 810 that utilizes additional hardware that is not already present on the hub device 810. As a non-limiting example, an application could be created that can be used to unlock and lock a door within an environment. In order to unlock and lock the door, however, additional hardware, such as a magnetic lock for the door, can be needed. If a user who owns a hub device 810 wants to utilize the application, they would also need to also purchase the additional hardware. It is contemplated that developers can upload an application that can present the option to buy the additional hardware, or the additional hardware can automatically be sent to the user when they download and/or buy the application. Once the additional hardware has received and installed the additional hardware, the user can utilize the application that was made by the developer and uploaded to the hub portal as the developer intended. In other words, the user can link the hub device 810 with the additional hardware or otherwise install the additional hardware to or on the hub device 810.

As discussed herein, the hub device 810 can include a set of preloaded software (e.g., software or code that is pre-existing on the memory accessible to the hub device 810). The preloaded software can define a first set of functions (e.g., detect for CO, smoke, voices, etc.). When a user downloads the application or otherwise edits the preloaded software, a set of additional software can be added to the memory accessible to the hub device 810. The additional software can define a second set of functions, different from the first set of functions, that can expand or redefine the functionality of the existing hardware component of the hub device 810 or otherwise define a method or way for the hub device 810 to communicate and utilize any additional hardware. The additional software is added after an installation of the hub unit 810 or otherwise after the production of the hub unit. As used herein, the term “production” refers to the making and assembling of the hub unit 810 along with the coding of the hub device (e.g., saving of the preloaded software to the memory accessible to the hub device 810). The second set of software can further include an additional set of communication instructions that allow for the hub device 810 to communicate with the additional hardware if the hub derive 810 is not already able to communicate with the additional hardware.

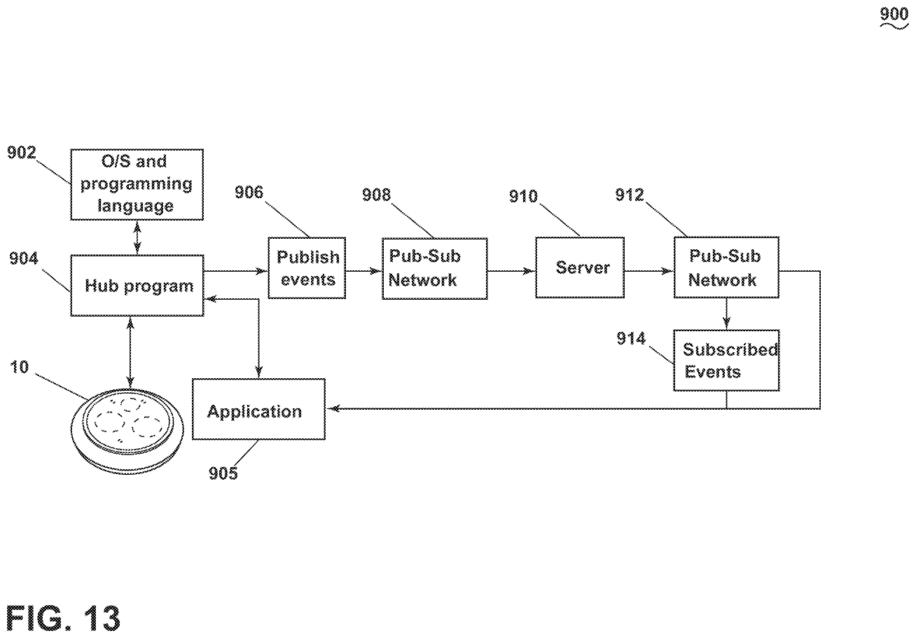

FIG. 13 is a hub environment 900 for the hub device 10 of FIG. 1. The hub environment 900 can be used to program one or more hardware functions of the hub device 10. Although described in terms of the hub device 10, it will be appreciated that the hub environment 900 can be used to program one more ore hardware functions of any of the hub devices 110, 210, 310, 410, 510, 610, 710, 810. The hub environment 900 can be defined as a programming environment for the hub device 10 and the method to access the code or programming of the hub device and ultimately dictate at least one hardware function or otherwise simulate the operation of the hub device 10. The hub environment 900 can be simulated through any suitable method such as through use of the developer tools 896 (FIG. 12), or the hub application 892 (FIG. 12).

A code for the hub device 10 can be written with any suitable OS programming language 902. As a non-limiting example, the OS programming language 902 can be, but is not limited to, procedural programming languages, functional programming languages, object-oriented programming languages, scripting programming languages, or logic programming languages. The OS programming language 902 can be based on the type of controller module 22 (FIG. 2) or the OS software of the hub device 10. As a non-limiting example, the controller module 22 can be configured to read logic programming languages, so therefore, the OS programming language 902 would be a logic programming language. The OS programming language 902 can be used to write the code that goes into a hub program 904, which defines the operation program of the hub device 10. In other words, the hub program 904 can define and dictate how the hub device 10 reacts when an input communication 66 (FIG. 3) is received, what the hardware functions are, or otherwise how the hub device 10 operates.

As illustrated, the hub program 904 and the hub device 10 are communicatively coupled to one another. As a non-limiting example, at least a portion of the hub program 904 can be provided on or otherwise be accessible to the controller module 22 of the hub device 10. It will be appreciated that the hub program 904 can be saved or otherwise accessible through the memory 58 of the hub device 10. As such, various hub data received from the input devices 14 (FIG. 2) or the communication devices 18 (FIG. 2) can be transferred to the controller module 22. The hub program 904 can then determine what needs to be done with said hub data. As a non-limiting example, the hub program 904 can dictate that the set of lights 38 (FIG. 2) need to be turned on when a low light threshold is detected by one of the input devices 14. The hub program 904 can further be at least partially accessible through an application 905 similar to the hub application 892 (FIG. 12), or fully accessible through an application similar to the developer tools 896 (FIG. 12). As such, an authorized (e.g., a user with a prior authorized unique developer identification) can access, rewrite, or otherwise edit the entirety of the hub program 904 through use of the developer tools 896, while a user that is not authorized can access, but not directly edit, the hub program 904 through use of the hub application 892. It is contemplated, however, that the user who is not authorized can still edit portions of the hub program 904, however, it will be appreciated that the access than an unauthorized user is granted is less than the access that a fully authorized user is granted. The application 905 can be accessed, by a user, through use of a user device. In the case of the application 905 being the developer tool 896, its sis contemplated that the application 905 can be defined as an Application Programming Interface (API) in which a user can utilize their user device to send a command to the hub device 10, edit the hub program 904, simulate the functionality of the hub device 10, or otherwise access the hub program 904.

During operation of the hub device 10 or during simulation of the operation of the hub device 10, one or more events 906 (e.g., hardware functions) can be received by or otherwise generated through the hub program 904. As a non-limiting example, the event 906 can include a sensor reading, a video, a time, an output (e.g., a light emission, a sound emission, etc.), a connection (e.g., a connection with another device, a connection with an internet or data connection, etc.), or any combination thereof. It will be further appreciated that the event 906 can be defined as an input from the user of the application 905. As a non-limiting example, the user can access the hub program 904 through the application 905 and input a fake, pre-generated, or otherwise synthetic event 906. This can be used for cases where the hub device 10 is not a physical hub device 10 and the user is instead only simulating the operation of the hub device 10.

The events 906 can ultimately be sent through a publish-subscribe network 908. As the events 906 are sent through the publish-subscribe network 908, the events 906 can be defined as published events 906 (e.g., events that are being communicated through a server or network). The publish-subscribe network protocol 908 can include a set of protocols (e.g., instructions) as to how to categorize, send, or otherwise decipher the published events 906. As a non-limiting example, the protocols can be based on the destination of the published events 906 after they are communicated through the publish-subscribe network 908. As a non-limiting example, the publish-subscribe network 908 can categorize the published events 906 that it receives based on their order of importance. The order of importance can be based on a chronological order that the published eve5tns were received or on whether or not the published events 906 are subscribed events. As used herein, the term “subscribed events” or iterations thereof, can refer to any published events 906 that the user or the hub program 904 are watching, monitoring, or otherwise looking for. As a non-limiting example, a subscribed event can be a hot-word, a detection of a threat, or a request from the user. It is contemplated that a subscribed event can take precedence over all other published events 906 such that the publish-subscribe network 908 can categorize a subscribed event at the highest order of importance or urgency.

The destination of the published events 906 from the publish-subscribe network 908 can be any suitable destination such as, but not limited to, a server 910. The server 910 can be defined as any system or set of systems including, but not limited to, computing devices (e.g., computers, processors, etc.), physical devices (e.g., a physical memory), digital machines, security systems, mechanical machines, migration systems, messaging systems, databases, or people. In other words, the server 910 can be defined as any suitable system or set of systems configured to perform various functions with or on the published event 906 or a set of published events 906 received from the publish-subscribe network 908. The server 910 can further include an internet connection (e.g., similar to the internet connection 883 of FIG. 12), such that an internet connection (e.g., over data or WIFI) is needed in order for the published events 906 to be sent to the server 910 and for the server to send an output as described herein to a destination. Alternatively, at least a portion of the server 910 can be run without an internet connection (e.g., through an offline connection). The server 910 can receive the published events 906 through the publish-subscribe network 908 in a format that is readable to the server 910. Alternatively, the server 910 can include a protocol that can convert, decipher, or otherwise read the published events 906 directly. In either case, the server 910 can perform various functions with the published events 906 based on the preference of the user of the hub environment 900.

As a non-limiting example, the user of the hub environment 900 can request that the published events 906 be saved to a server-based storage run by or otherwise accessible through the server 910. As such, the server 910 can receive the published events 906 and store them within the server-based storage. As a non-limiting example, the user of the hub environment 900 can request that the published event 906 or a set of published events 906 stored within the server-based storage be analyzed to identify trends or otherwise read the values and convert them into a human-readable format. As a non-limiting example, the server 910 could include a set of published events 906 relating to a temperature of an environment that the hub device 10 is provided within. The server 910 could store these published events 906 and analyze them to determine the time that the published events 906 were created (e.g., the time the temperature was taken) and what the temperature value was. A trend could be established, by the server 910, to determine how the temperature is changing over time.

In any case, the server 910 can be configured to define an output including a set of data including at least a portion of the published event 906. The set of data output from the server 910 can be any analyzed, categorized, or computed data relating to the published events 906 that is analyze, categorized or computed based on the preference or input of the user, or through an automatic determination by the server 910. The output can be sent through an additional publish-subscribe network 912 similar to the publish subscribe network 908. The additional publish-subscribe network 912 can include a set of protocols that can read or otherwise decipher the output from the server 910. The additional publish-subscribe network 912 can then convert the output into a destination-readable format based on the destination of an output from the additional publish-subscribe network 912. It will be appreciated that the server 910 can include instructions as to where to send the output or otherwise send the output directly to the destination. With the latter, the server 910 can automatically convert, or otherwise decipher the output into a format that is readable by the destination.

There can be multiple destinations for the output of the server 910. As a non-limiting example, the destination can be at least one of a memory (e.g., a server-based memory, or a physical memory) or the application 905 defined either by the developer tools (e.g., the developer tools 896) or the hub application (e.g., the hub application 892). In the case of the output being sent to the memory, the output can be saved or otherwise stored within at least one memory accessible to the user, the server 910, or the hub device 10. In the case of the output being sent to the application 905, it will be appreciated that the output can be sent directly to the application 905 such that the user of the application 905 can view everything that is being output form the server 910. As such, the user can view all of the outputs of the server (e.g., the deciphered data, the analyzed data, the analyzed trends, etc.). Alternatively, it is contemplated that only a portion of the output might be sent and viewed through the application 905. As a non-limiting example, only subscribed events 914 might be viewed through the application 905. The subscribed events 914, as discussed herein, can be defined as events (e.g., published events 906) of high importance or otherwise requested by the user of the application 905. In any case, the user of the application 905 can view the output of the server 910 and user the output to view the operation of the corresponding hub device 10.

With the described hub environment 900, the user of the application can view or edit the programming (e.g., the OS programming language 902) of the hub device, view the output, inputs, or communication of the hub device (e.g., through the output of the server 910), or otherwise simulate the operation of the hub device 10 (e.g., through the output of the server 910 and the physical input of published events 906).

As a non-limiting example, the described hub environment 900 can further be used for operation of the application 905 including a hub application (e.g., the hub application 892 of FIG. 12). It is contemplated that the user of the hub device 10 can download one or more applications 905 from the hub portal 898 (FIG. 12). These applications 905 can be run on or otherwise executed through the hub program 904 such that the hub device 10 can operate according to the application 905. As such, the application 905 defined by the hub application can utilize the hub environment 900 described herein by subscribing to certain events from the hub device 10. As a non-limiting example, the application 905 can be used to monitor a temperature of an environment that the hub device 10 is provided within and notify the user when the temperature reaches a maximum threshold temperature value. It is contemplated that the application 905 can subscribe to an event that corresponds to when a published event 906 relating to the temperature of the environment occurs that is greater than or equal to the maximum threshold temperature value. As such, when the threshold temperature value is reached or exceeded, an input, defined by the subscribed event 914, can be sent to the application 905. The input to the application 905 can be used in a multitude of ways that are dependent on the desire of the developers of the application 905. In other words, the developers of the application 905 can decide what the application does with the input that is ultimately received from the hub device 10. As a non-limiting example, if the maximum threshold temperature value is reached, the application 905 might send a command to the hub device 10, through the hub program 904, to notify a user through an audible message or to communicate with a connected environmental control system (e.g., an external device defined by an air conditioning system, a heating system, etc.) to raise or lower the temperature in the environment the hub device 10 is provided within so the temperature is no longer exceeding or equal to the maximum threshold temperature value. Alternatively, the user of the application 905 or the application can automatically send without input from the user instructions to the hub device 10 without first receiving an input from the hub device 10.

Benefits of the present disclosure include a hardware device with a wider range of hardware functions when compared to conventional hardware devices. For example, conventional hardware devices can include a limited number of hardware elements configured to perform a limited number of hardware functions. For example, a conventional hardware device can be a smoke detector with a smoke sensor. When smoke is detected by the smoke sensor, an alarm can go off to notify a user of the smoke detector. However, that is all the smoke detector is designed to do. It is limited in the total number of hardware functions that it can perform. The hardware device as descried herein, however, can be defined as a hardware hub device as it can include a plethora of hardware devices that perform various hardware functions. In comparison with the conventional hardware device, the hardware hub device as described herein can perform a greater amount of hardware functions. As a non-limiting example, the hardware hub device can include a smoke detector such that it can function as a smoke detector (e.g., similar to the conventional hardware device described above), however, it can also include an AI system so the user could use the hardware hub device as an AI device, a CO sensor, a light source, a projector, or any other suitable input device, output device, or communication device as described herein. In other words, the hardware hub device can have a much greater range of hardware functions when compared to conventional hardware devices.

Further benefits of the present disclosure include a hardware hub device with greater versatility when compared to a conventional hardware device. For example, the conventional hardware device, as described above, can include a limited number of hardware devices, and hence a limited number of hardware functions. These hardware functions and hardware devices are non-programmable. In other words, the hardware functions cannot, be changed. The hardware hub device as described herein., however, allows for a greater versatility as an authorised user of the devolvement tools of the hardware hub device can add on to the functionality of the hardware hub device through creation of applications that include hardware kits and/or software kits. As discussed herein, the hardware kits can expand onto the hardware capabilities (e.g., the input devices, the output devices, or the communication devices) by introducing additional input devices, output devices, or communication devices that can either be installed on the hardware hub device or otherwise connected (e.g., paired) with the hardware hub device. Further, the software kits can work in conjunction with the hardware kits or otherwise expand on the functionality of the hardware hub device by incorporating additional functionalities of the hardware hub device and its existing input devices, output devices, or communication devices. A user of the hardware hub device can then pick and choose which applications they want to be run on the hardware hub device and therefore change the functionality or otherwise add onto the functionality of the hardware hub device by downloading, installing, or purchasing the applications including the hardware kits, or the software kits. As such, the functionality of the hardware hub device can constantly be evolved and added onto without the end to buy a new hardware hub device that includes new software or hardware. Instead, the user can buy or download applications including the hardware kits or the software, kits from the hub portal and download or install them on their existing hardware hub devices. This, in turn, allows for a much greater versatility in the overall functionality of the hardware huh device when compared to conventional hardware devices.

To the extent not already described, the different features and structures of the various aspects can be used in combination with each other as desired. That one feature cannot be illustrated in all of the aspects is not meant to be construed that it cannot be, but is done for brevity of description. Thus, the various features of the different aspects can be mixed and matched as desired to form new aspects, whether or not the new aspects are expressly described. Combinations or permutations of features described herein are covered by this disclosure.

This written description uses examples to describe aspects of the disclosure described herein, including the best mode, and also to enable any person skilled in the art to practice aspects of the disclosure, including making and using any devices or systems and performing any incorporated methods. The patentable scope of aspects of the disclosure is defined by the claims, and can include other examples that occur to those skilled in the art. Such other examples are intended to be within the scope of the claims if they have structural elements that do not differ from the literal language of the claims, or if they include equivalent structural elements with

What is claimed is:

1. A hub device comprising:
a housing defining an interior;
a plurality of sensors provided within the interior or along a portion of the housing; and
a controller module having access to a memory comprising:
a set of preloaded software that is pre-existing on the memory before an installation of the hub device, the set of preloaded software being configured to allow the hub device to perform according to a first set of functions using at least one sensor of the plurality of sensors; and
a set of additional software that is saved to the memory after the installation or the production of the hub device, the set of additional software being configured to allow the hub device to perform according to a second set of functions using at least one sensor of the plurality of sensors, with the first set of functions being different from the second set of functions;
wherein at least one additional hardware that is not preexisting on or with the hub device, and wherein at least one of the set of preloaded software or the set of additional software is configured to allow the at last one additional hardware to be communicatively couplable to the hub device.

2. The hub device of claim 1, wherein the set of additional software and the additional hardware are included within a singular kit.

3. The hub device of claim 2, wherein a user of the hub device can obtain the singular kit including the set of additional software and the additional hardware.

4. The hub device of claim 3, wherein the additional software is automatically downloaded to the memory accessible to the hub device after the user obtains the singular kit.

5. The hub device of claim 3, wherein the additional hardware is automatically sent to or purchased for the user when the singular kit is obtained by the user.

6. The hub device of claim 1, wherein the hub device is included within a network of hub devices.

7. The hub device of claim 6, wherein each hub device of the network of hub devices includes a respective memory having the set of preloaded software and the set of additional software.

8. The hub device of claim 6, wherein each hub device of the network of hub devices includes a respective plurality of sensors.

9. The hub device of claim 8, wherein a first hub device of the network of hub devices can communicate with a sensor of the plurality of sensors of a second hub device of the network of hub devices.

10. The hub device of claim 1, wherein the hub device is communicatively coupled with an existing network of an environment that the hub device is provided within, the hub device further comprising a network relay that transmits the existing network from the hub device.

11. The hub device of claim 1, wherein the existing network is a WiFi network and the hub device is configured to transmit and enhance the WiFi network.

12. The hub device of claim 1, wherein the set of additional software is developed through use of a developer tool configured to edit at least a portion of the set of preloaded software.

13. The hub device of claim 12, wherein the developer tool includes a set of user data that is used to simulate a function of the hub device, with the set of user data is a set of real-world user data or a set of synthetic data.

14. The hub device of claim 1, wherein the plurality of sensors include any combination of two or more of a carbon monoxide sensor, an O2 sensor, a motion sensor, a proximity sensor, a smoke sensor, a temperature sensor, a humidity sensor, a pressure sensor, a vibration sensor, a thermal sensor, an optical sensor, a dust sensor, a gas sensor, a distance sensor, a motion sensor, a light sensor, a color sensor, a flame sensor, a gesture sensor, barometric sensor, an air quality sensor or a human presence sensor.

15. The hub device of claim 1, further comprising a plurality of communication devices, with each communication device configured to transmit and receive communications over a respective wireless mesh network.

16. The hub device of claim 15, wherein the additional hardware is communicatively couplable with the hub device over one of the communication devices.

17. The hub device of claim 15, further comprising a first additional hardware and a second additional hardware, each being communicatively couplable to the hub device.

18. The hub device of claim 17, wherein the first hardware is communicatively couplable to the hub device via a first wireless mesh network using a first communication device of the plurality of communication devices, and the second hardware is communicatively couplable to the hub device via a second wireless mesh network, different from the first wireless mesh network, using a second communication device of the plurality of communication devices.

19. A method of defining a functionality of a hub device having a plurality of sensors and a controller module with a memory accessible to the controller module, the method comprising:
saving a first set of software to the memory during production of the hub device, the first set of software defining a first set of functions utilizing at least one sensor of the plurality of sensors;
saving a second set of software to the memory after production of the hub device, the second set of software defining a second set of functions, different from the first set of function; and
communicating with an additional hardware that is not preexisting on or with the hub device, and wherein at least one of the set of preloaded software or the set of additional software is configured to allow the hub device to be communicatively couplable to the hub device.

20. The method of claim 19, wherein the second set of software is included within a singular kit further comprising an additional hardware, with the second set of software being configured to allow the hub device to communicate with the additional hardware.
